(19) United States
(12) Patent Application Publication
(10) Pub. No.: US 2023/0357595 A1
(43) Pub. Date: Nov. 9, 2023

(54) CORROSION RESISTANT ADHESIVE SOL-GEL

(71) Applicant: THE BOEING COMPANY, Arlington, VA (US)

(72) Inventors: Waynie M. SCHUETTE, Troy, IL (US); Vivek KAPILA, Edmond, OK (US)

(21) Appl. No.: 18/144,038

(22) Filed: May 5, 2023

Related U.S. Application Data
(60) Provisional application No. 63/339,276, filed on May 6, 2022.

(51) Int. Cl. C09D 183/04; C09D 163/00

(52) U.S. Cl. CPC C09D 183/04; C09D 163/00

(57) ABSTRACT

The present disclosure relates to a systems and methods for a coated substrate having a metal substrate and a sol-gel coating disposed on the metal substrate. The sol-gel includes a corrosion inhibitor, a surfactant and a reaction product of an epoxy-containing organosilane, a metal alkoxide, and an acid. The coated substrate includes an organic primer coating having an organic primer having a plurality of metal particles.

### CROSS-REFERENCE TO RELATED APPLICATION

This present disclosure is a U.S. Non-Provisional Patent Application, which claims benefit of U.S. Provisional Patent Application No. 63/339,276, filed May 6, 2022. The aforementioned related patent application is incorporated herein by reference in its entirety.

### FIELD

Aspects of the present disclosure generally relate to corrosion resistant sol-gel films for aerospace applications.

### BACKGROUND

Metals, such as steel, aluminum, aluminum alloys, and galvanized metals, used in the manufacture of aircraft, spacecraft, and other machinery can be susceptible to corrosion. Chromates, such as zinc salts of hexavalent chromium, have been used as corrosion inhibitors in corrosion inhibiting coatings such as in paints, sealants and primers. However, the chromates and other corrosion inhibitors often exhibit poor adhesion to the metal substrate. Moreover, there is regulatory pressure to eliminate the use of hexavalent chromium and other chromates from conversion coatings, primers, and manufacturing processes.

Conventionally, adhesive sol-gel films have been disposed at the interface between the metal substrate and the corrosion inhibitor to promote adhesion. However, the adhesive sol-gels do not themselves possess corrosion resistance properties. As such, over time, pores form in the sol-gel that retain water, promoting corrosion of the metal surface. Attempts to incorporate corrosion inhibitors lacking chromates and other primers such as aluminum primers are desired to increase adhesive ability to the metal substrate or a primer disposed on the sol-gel, while maintaining anticorrosion ability.

Therefore, there is a need in the art for sol-gels having corrosion inhibition capabilities that maintain adequate adhesion to a metal substrate when coated with a primer coating.

### SUMMARY

The present disclosure relates to a coated substrate having a metal substrate and a sol-gel coating disposed on the metal substrate. The sol-gel includes a corrosion inhibitor, a surfactant and a reaction product of an epoxy-containing organosilane, a metal alkoxide, and an acid. The coated substrate includes an organic primer coating having an organic primer having a plurality of metal particles.

The present disclosure also relates to a method for preparing a coated substrate. The method includes applying a sol-gel coating to a metal substrate to form the sol-gel coating, the sol-gel coating comprising a corrosion inhibitor. The method includes applying a primer coating to the sol-gel coating to form the primer coating, the primer coating comprising a metal.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1 is a side view of a corrosion-inhibiting sol-gel disposed on a substrate, according to aspects of the disclosure.

FIG. 2 is a schematic of a method for preparing a coated substrate, according to aspects of the disclosure.

FIG. 3 is an illustrative potentiodynamic scan of the metal surface of corrosion-resistant sol-gels, according to aspects of the disclosure.

FIG. 4 is an illustrative OPR current graph of corrosion-resistant sol-gels, according to aspects of the disclosure.

FIG. 5 is an illustrative current-voltage graph of corrosion-resistant sol-gels at the surface of the electrode, according to aspects of the disclosure.

FIGS. 6A and 6B are depictions of SEM images of corrosion-resistant sol gels, according to aspects of the disclosure. FIG. 6A is an SEM image of a thin corrosion-resistant sol-gel. FIG. 6B is an SEM image of a thick corrosion-resistant sol-gel.

FIG. 7 is an illustrative corrosion-resistant sol-gel thickness graph of corrosion-resistant sol-gels, according to aspects of the disclosure.

FIG. 8 is an illustrative corrosion-resistant sol-gel coating weight graph of corrosion-resistant sol-gels, according to aspects of the disclosure.

FIG. 9 is illustrative absorption spectra of corrosion-resistant sol-gels, according to aspects of the disclosure.

FIG. 10 is an illustrative current-voltage graph of corrosion-resistant sol-gels, according to aspects of the disclosure.

FIG. 11 depicts a corrosion resistant-sol gel after 336 h on bare 2024-T3, according to aspects of the disclosure.

FIG. 12 is an illustrative impedance-frequency spectra of corrosion-resistant sol-gels, according to aspects of the disclosure.

FIGS. 13A-13F are depictions of substrates coated with corrosion-resistant sol gels and comparatives after 2000 h of ASTM B117 exposure, according to aspects of the disclosure. FIG. 13A is a first substrate coated with a comparative after 2000 h of ASTM B117 exposure. FIG. 13B is a first substrate coated with a first corrosion resistant sol-gel after 2000 h of ASTM B117 exposure. FIG. 13C is a first substrate coated with a second corrosion resistant sol-gel after 2000 h of ASTM B117 exposure. FIG. 13D is a second substrate coated with a comparative after 2000 h of ASTM B117 exposure. FIG. 13E is a second substrate coated with a first corrosion resistant sol-gel after 2000 h of ASTM B117 exposure. FIG. 13E is a second substrate coated with a second corrosion resistant sol-gel after 2000 h of ASTM B117 exposure.

FIGS. 14A-14C are depictions of bare 7075-T6 panels coated with corrosion-resistant sol gels and comparatives after 9 months of outdoor exposure, according to aspects of the disclosure. FIG. 14A is bare 7075-T6 coated with a comparative. FIG. 14B is bare 7075-T6 coated with a first corrosion resistant sol-gel. FIG. 14C is bare 7075-T6 coated with a second corrosion resistant sol-gel.

FIGS. 15A-15F are depictions of bare A1 7075-T6 panels with comparatives and corrosion-resistant sol-gel pretreatments with various primers after 2000 h exposure to NSS chamber, according to aspects of the disclosure. FIG. 15A depicts a bare A1 7075-T6 panel with a comparative pretreatment with Av-de A1 rich. FIG. 15B depicts a bare A1 7075-T6 panel with a first corrosion resistant sol-gel pretreatment with Av-de A1 rich. FIG. 15C depicts a bare A1 7075-T6 panel with a second corrosion resistant sol-gel pretreatment with Av-de A1 rich. FIG. 15D depicts a bare A1 7075-T6 panel with a comparative pretreatment with Akzo Nobel Aerodur 2118.

FIG. 15E depicts a bare A1 7075-T6 panel with a first corrosion resistant sol-gel pretreatment with Akzo Nobel Aerodur 2118. FIG. 15F depicts a bare A1 7075-T6 panel with a second corrosion resistant sol-gel pretreatment with Akzo Nobel Aerodur 2118.

FIGS. 16A-16D are depictions of bare 7075-T6 panels with Alodine 1200S as pretreatment, various primers and PPG 99GY001 polyurethane topcoat after 3000 h of ASTM B117 testing, according to aspects of the disclosure. FIG. 16A depicts a bare 7075-T6 panel with a PPG RW7171-64 primer. FIG. 16B depicts a bare 7075-T6 panel with an Av-dec A1 rich primer. FIG. 16C depicts a bare 7075-T6 panel with an Aerodur 2118 primer. FIG. 16D depicts a bare 7075-T6 panel with a PPG CA7231 primer.

FIGS. 17A-17D are depictions of bare 7075-T6 panels with Alodine 5900 as pretreatment, various non-chromate primers and PPG 99GY001 polyurethane topcoat after 3000 h of ASTM B117 testing, according to aspects of the disclosure. FIG. 17A depicts a bare 7075-T6 panel with a PPG RW 7171-64 primer. FIG. 17B depicts a bare 7075-T6 panel with an Av-dec A1 rich primer. FIG. 17C depicts a bare 7075-T6 panel with an Aerodur 2118 primer. FIG. 20D depicts a bare 7075-T6 panel with a PPG CA7231 primer.

FIGS. 18A-18D are depictions of bare 7075-T6 panels with SurTec 650V as pretreatment, various non-chromate primers and PPG 99GY001 polyurethane topcoat after 3000 h of ASTM B117 testing, according to aspects of the disclosure. FIG. 18A depicts a bare 7075-T6 panel with a PPG RW 7171-64 primer. FIG. 18B depicts a bare 7075-T6 panel with an Av-dec A1 rich primer. FIG. 18C depicts a bare 7075-T6 panel with an Aerodur 2118 primer. FIG. 18D depicts a bare 7075-T6 panel with a PPG CA7231 primer.

FIGS. 19A-19D are depictions of bare 7075-T6 panels with corrosion-resistant sol-gels of the present disclosure with DMCT as pretreatment, various non-chromate primers and PPG 99GY001 polyurethane topcoat after 3000 h of ASTM B117 testing, according to aspects of the disclosure. FIG. 19A depicts a bare 7075-T6 panel with a PPG RW 7171-64 primer. FIG. 19B depicts a bare 7075-T6 panel with an Av-dec A1 rich primer. FIG. 19C depicts a bare 7075-T6 panel with an Aerodur 2118 primer. FIG. 19D depicts a bare 7075-T6 panel with a PPG CA7231 primer.

FIGS. 20A-20D are depictions of 7178 panels with Alodine 1200S as pretreatment, various non-chromate primers and PPG 99GY001 polyurethane topcoat after 3000 h of ASTM B117 testing, according to aspects of the disclosure. FIG. 20A depicts a bare 7178 panel with a PPG RW 7171-64 primer. FIG. 20B depicts a bare 7178 panel with an Av-dec A1 rich primer. FIG. 20C depicts a bare 7178 panel with an Aerodur 2118 primer. FIG. 20D depicts a bare 7178 panel with a PPG CA7231 primer.

FIGS. 21A-21C are depictions of 7178 panels with Alodine 5900 as pretreatment, various non-chromate primers and PPG 99GY001 polyurethane topcoat after 3000 h of ASTM B117 testing, according to aspects of the disclosure. FIG. 21A depicts a bare 7178 panel with a PPG RW 7171-64 primer. FIG. 21B depicts a bare 7178 panel with an Av-dec A1 rich primer. FIG. 21C depicts a bare 7178 panel with an Aerodur 2118 primer.

FIGS. 22A-22C are depictions of 7178 panels with SurTec 650V as pretreatment, various non-chromate primers and PPG 99GY001 polyurethane topcoat after 3000 h of ASTM B117 testing, according to aspects of the disclosure. FIG. 22A depicts a bare 7178 panel with a PPG RW 7171-64 primer. FIG. 22B depicts a bare 7178 panel with an Av-dec A1 rich primer. FIG. 22C depicts a bare 7178 panel with an Aerodur 2118 primer.

FIGS. 23A and 23B are depictions of 7178 panels with corrosion-resistant sol-gels of the present disclosure with DMCT as pretreatment, various non-chromate primers and PPG 99GY001 polyurethane topcoat after 3000 h of ASTM B117 testing, according to aspects of the disclosure. FIG. 23A depicts a bare 7178 panel with a PPG RW 7171-64 primer. FIG. 23B depicts a bare 7178 panel with an Av-dec A1 rich primer.

FIG. 24 is an illustrative graph comparing ranking using multiple methods on 7075-T6 test panels that completed 3000 h exposure to NSS chamber, according to aspects of the disclosure.

FIG. 25 is an illustrative graph comparing ranking using multiple methods on 7178 test panels that completed 2000 h exposure to NSS chamber, according to aspects of the disclosure.

FIG. 26 is an illustrative graph comparing ranking on 7075-T6 test panels that completed 3000 h exposure to NSS chamber and 672 h exposure to the cyclic accelerated chamber, according to aspects of the invention.

FIG. 27 is an illustrative graph comparing ranking on 7178 test panels that completed 3000 h exposure to NSS chamber and 672 h exposure to the cyclic accelerated chamber, according to aspects of the invention.

### DETAILED DESCRIPTION

Aspects of the present disclosure generally relate to corrosion resistant sol-gels for aerospace applications. Sol-gels of the present disclosure include (or the reaction product of) an epoxy-containing organosilane, a metal alkoxide, an acid stabilizer, about 3 wt % to about 15 wt % corrosion inhibitor by volume of the total sol-gel coating, and a surfactant. It has been discovered that a surfactant present in a sol-gel prevents or reduces porosity and blistering of a sol-gel/primer coating on a metal surface, providing a corrosion inhibiting ability of a sol-gel film because accumulation of water within the sol-gel is prevented or reduced. The surfactant also allows for increased wettability of the coating on the surface of the metal, improving coating adhesion and corrosion performance. Additionally, it has been discovered that the use of an organic primer disposed on a corrosion resistant sol-gel having a plurality of metal particles, e.g. aluminum, lithium, or the like, leads to enhanced corrosion protection of alloys (e.g., aerospace alloys). Sol-gels of the present disclosure have corrosion inhibiting ability, and, primers (disposed on the sol-gel) can be either non-chrome containing primers or chrome containing primers.

Methods for preparing a coated substrate of the present disclosure include applying a sol-gel coating to a metal substrate to form the sol-gel coating. The sol-gel coating comprises a corrosion inhibitor in an amount of about 3 wt % by volume of corrosion inhibitor to sol-gel coating to about 15 wt % by volume of corrosion inhibitor to sol-gel coating.

### Metal Substrate

A metal substrate includes a metal aircraft surface, which can include steel or an alloy having a major component, such as aluminum. The metal substrate can include a major component and a minor component, known as an intermetallic. Intermetallics, for example, can contain copper metal which can be prone to corrosion. The metal substrate can include an aluminum substrate. The metal substrate can include an aluminum substrate with an intermetallic of copper. As a non-limiting example, the metal substrate can be a 7075-T6 aluminum substrate or a 7178 aluminum substrate.

### Sol-Gels

The term “sol-gel,” a contraction of solution-gelation, refers to a series of reactions wherein a soluble metal species (typically a metal alkoxide or metal salt) hydrolyze to form a metal hydroxide. The soluble metal species usually contain organic ligands tailored to correspond with the resin in the bonded structure. A soluble metal species undergoes hetero hydrolysis and hetero condensation forming hetero metal bonds e.g. Si—O—Zr. In the absence of organic acid, when metal alkoxide is added to water, a white precipitate of, for example, Zr(OH)₂ rapidly forms. Zr(OH)₂ is not soluble in water, which hinders sol-gel formation. The acid is added to the metal alkoxide to allow a water-based system. Depending on reaction conditions, the metal polymers can condense to colloidal particles or they can grow to form a network gel. The ratio of organics to inorganics in the polymer matrix is controlled to maximize performance for a particular application.

The sol-gel has a thickness of about 50 nm to about 4 μm, e.g., about 100 nm to about 2.5 μm, such as about 100 nm, about 200 nm, about 300 nm, about 400 nm, about 500 nm, about 600 nm, about 700 nm, about 800 nm, about 900 nm, about 1 μm, about 2 μm, about 2.5 μm, or the like. The sol-gel has a weight of about 30 mg/ft² to about 1,000 mg/ft², e.g., about 30 mg/ft² to about 400 mg/ft², or about 250 mg/ft² to about 1000 mg/ft², such as, for example, about 30 mg/ft², about 100 mg/ft², about 200 mg/ft², about 300 mg/ft², about 400 mg/ft², about 500 mg/ft², about 600 mg/ft², about 700 mg/ft², about 800 mg/ft², about 900 mg/ft², about 1000 mg/ft², or the like.

### Organosilane

A weight fraction (wt %) of organosilane in the sol-gel is from about 0.1 wt % to about 20 wt % by volume of the total sol-gel coating, such as from about 0.3 wt % to about 15 wt %, such as from about 0.5 wt % to about 10 wt %, such as from about 0.7 wt % to about 5 wt %, such as from about 1 wt % to about 2 wt %, for example about 1 wt %, about 1.5 wt %, about 2 wt %.

Organosilanes of the present disclosure are represented by formula (I):

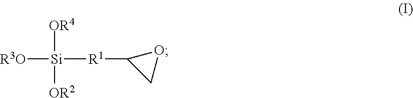

wherein:
each of R², R³, and R⁴ is independently linear or branched C₁₋₂₀ alkyl. C₁₋₂₀ alkyl includes methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosanyl;
R¹ is selected from alkyl, cycloalkyl, ether, and aryl. Alkyl includes linear or branched C₁₋₂₀ alkyl. C₁₋₂₀ alkyl includes methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosanyl. Ether includes polyethylene glycol ether, polypropylene glycol ether, C₁-C₂₀ alkyl ether, aryl ether, and cycloalkyl ether.

Ether is selected from:

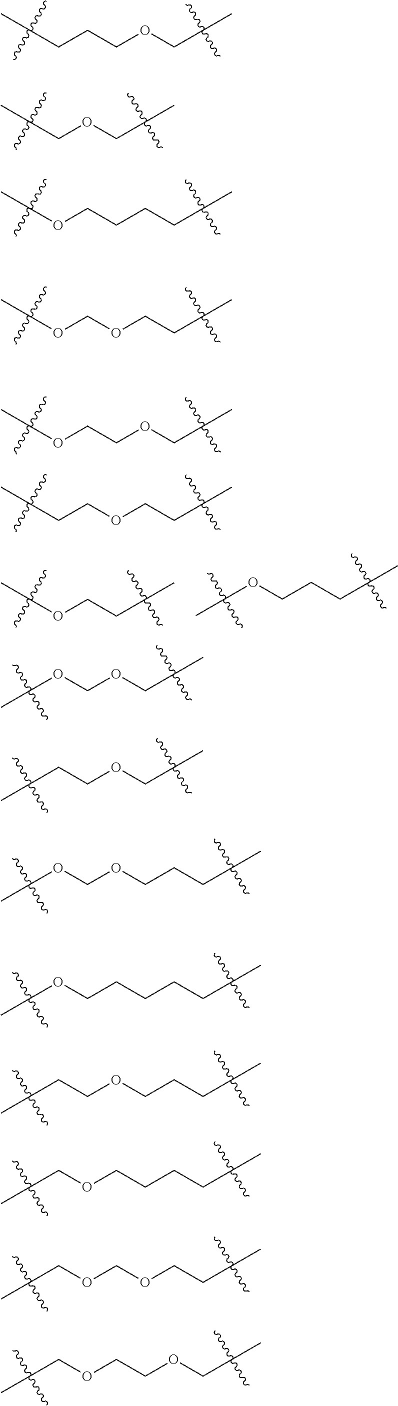

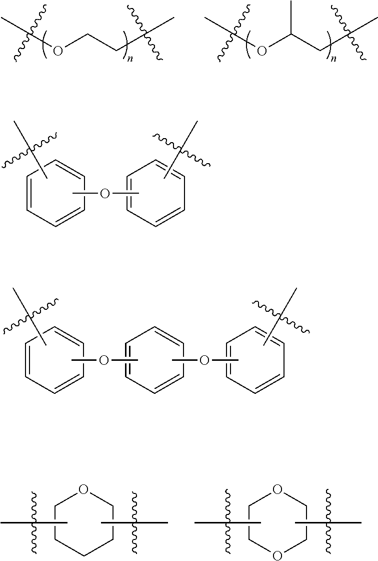

wherein n is a positive integer. In at least one aspect, n is a positive integer and the number average molecular weight (Mn) of the ether is from about 300 to about 500, such as from about 375 to about 450, such as from about 400 to about 425.

An organosilane is a hydroxy organosilane. Hydroxy organosilanes are substantially unreactive toward nucleophiles, e.g., some corrosion inhibitors. Hydroxy organosilanes of the present disclosure are represented by formula (II):

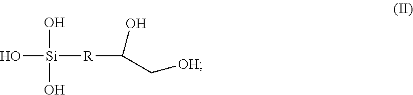

wherein R is selected from alkyl, cycloalkyl, ether, and aryl. Alkyl includes linear or branched C₁₋₂₀alkyl. C₁₋₂₀ alkyl includes methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosanyl. Ether includes polyethylene glycol ether, polypropylene glycol ether, C₁-C₂₀ alkyl ether, aryl ether, and cycloalkyl ether.

Ether is selected from:

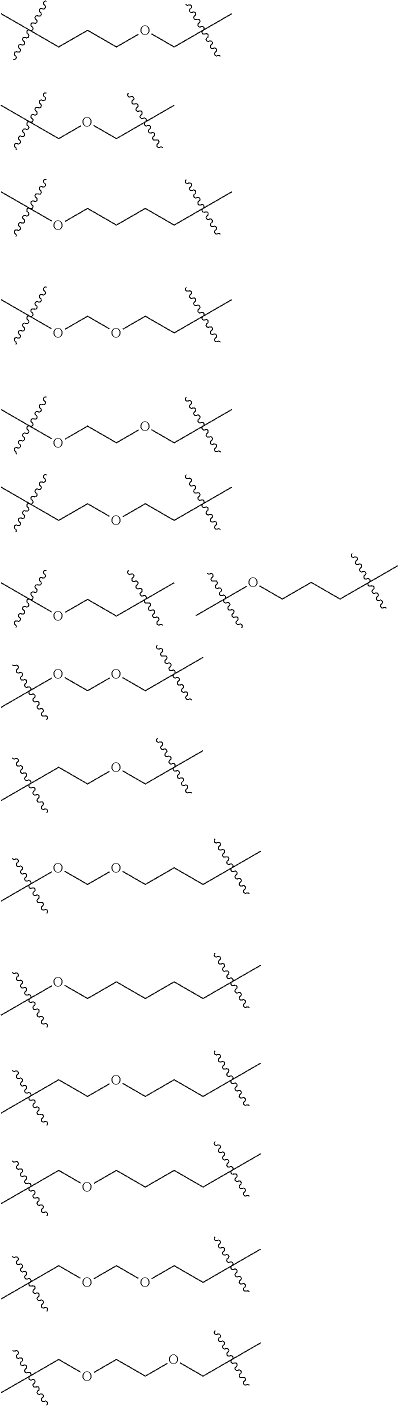

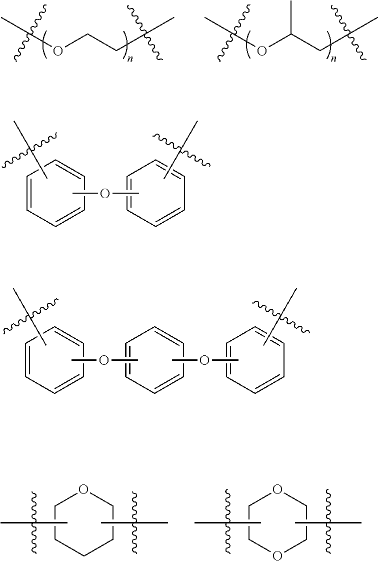

wherein n is a positive integer. In at least one aspect, n is a positive integer and the number average molecular weight (Mn) of the ether is from about 300 to about 500, such as from about 375 to about 450, such as from about 400 to about 425.

The organosilane is represented by compound 1 or compound 2:

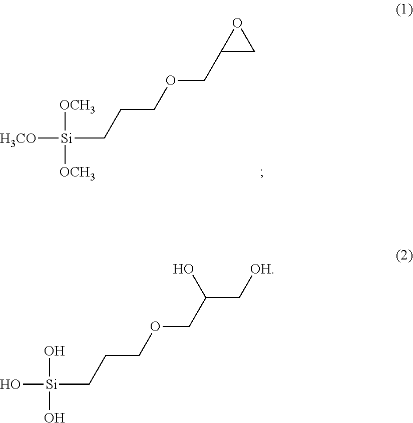 [SMILES: CO[Si](CCCOCC1CO1)(OC)OC ; OCC(O)COCCC[Si](O)(O)O]

An organosilane is selected from 3-aminopropyltriethoxysilane, 3-glycidoxy-propyltriethoxysilane, p-aminophenyltrimethoxysilane, p-aminophenyltriethoxysilane, allyltrimethoxysilane, allyltriethoxysilane, n-(2-aminoethyl)-3-aminopropyltrimethoxysilane, 3-aminopropyltriethoxysilane, 3-aminopropyltrimethoxysilane, 3-glycidoxypropyldiisopropylethoxysilane, (3-glycidoxypropyl)methyldiethoxysilane, 3-glycidoxypropyltrimethoxysilane, 2-(3,4-epoxycyclohexyl)ethyltrimethoxysilane, 2-(3,4-epoxycyclohexyl)ethyltriethoxysilane, 3-mercaptopropyltrimethoxysilane, 3-mercaptopropyltriethoxysilane, 3-methacryloxypropylmethyldiethoxysilane, 3-methacryloxypropylmethyldimethoxysilane, 3-methacryloxypropyltrimethoxysilane, n-phenylaminopropyltrimethoxysilane, vinylmethyldiethoxysilane, vinyltriethoxysilane, vinyltrimethoxysilane, bis(trimethoxysilyl)ethane, bis(triethoxysilyl)ethane, bis[3-(trimethoxysilyl)propyl]amine, bis[3-(triethoxysilyl)propyl]amine, bis[3-(triethoxysilyl)propyl]disulfide, bis[3-(trimethoxysilyl)propyl] disulfide, bis[3-(triethoxysilyl)propyl] trisulfide, bis[3-(trimethoxysilyl)propyl] trisulfide, bis[3-(triethoxysilyl)propyl] tetrasulfide, and bis[3-(trimethoxysilyl)propyl] tetrasulfide.

An organosilane useful to form sol-gels of the present disclosure provides an electrophilic silicon and/or epoxide moiety that can react with a nucleophile, such as a hydroxy-containing nucleophile. An organosilane of the present disclosure provides a sol-gel having reduced porosity and blistering as compared to conventional sol-gels.

### Metal Alkoxide

A metal alkoxide useful to form sol-gels of the present disclosure provides metal atoms coordinated in a sol-gel for adhesive and mechanical strength. Metal alkoxides of the present disclosure include at least one of zirconium alkoxides, titanium alkoxides, hafnium alkoxides, yttrium alkoxides, cerium alkoxides, and lanthanum alkoxides. Metal alkoxides can have four alkoxy ligands coordinated to a metal that has an oxidation number of +4. Non-limiting examples of metal alkoxides are zirconium (IV) tetramethoxide, zirconium (IV) tetraethoxide, zirconium (IV) tetra-n-propoxide, zirconium (IV) tetra-isopropoxide, zirconium (IV) tetra-n-butoxide, zirconium (IV) tetra-isobutoxide, zirconium (IV) tetra-n-pentoxide, zirconium (IV) tetra-isopentoxide, zirconium (IV) tetra-n-hexoxide, zirconium (IV) tetra-isohexoxide, zirconium (IV) tetra-n-heptoxide, zirconium (IV) tetra-isoheptoxide, zirconium (IV) tetra-n-octoxide, zirconium (IV) tetra-n-isooctoxide, zirconium (IV) tetra-n-nonoxide, zirconium (IV) tetra-n-isononoxide, zirconium (IV) tetra-n-decyloxide, and zirconium (IV) tetra-n-isodecyloxide.

The sol-gel includes a metal alkoxide content, in which the metal alkoxide content is the reaction product of the metal alkoxide that forms in the sol-gel. A weight fraction (wt %) of metal alkoxide content by volume in the total sol-gel coating is from about 0.1 wt % to about 10 wt %, such as from about 0.2 wt % to about 5 wt %, such as from about 0.3 wt % to about 3 wt %, such as from about 0.4 wt % to about 2 wt %, such as from about 0.5 wt % to about 1 wt %, for example about 0.2 wt %, about 0.5 wt %, about 1 wt %.

### Acid Stabilizer

An acid stabilizer used to form sol-gels of the present disclosure provides stabilization of a metal alkoxide and a corrosion inhibitor of the sol-gel as well as pH reduction of the sol-gel. The pH value of the sol-gel (and composition that forms the sol-gel) can be controlled by use of an acid stabilizer. Acid stabilizers of the present disclosure include organic acids. Organic acids include acetic acid (such as glacial acetic acid) or citric acid. Less acidic acid stabilizers (e.g., pKa greater than that of acetic acid) can also be used, such as glycols, ethoxyethanol, or H₂NCH₂CH₂OH.

A pH of a sol-gel of the present disclosure is from about 2 to about 5, such as about 3 to about 4. A weight fraction (wt %) of acid stabilizer by volume in the total sol-gel is from about 0.1 wt % to about 10 wt %, such as from about 0.2 wt % to about 5 wt %, such as from about 0.3 wt % to about 3 wt %, such as from about 0.4 wt % to about 2 wt %, such as from about 0.5 wt % to about 1 wt %, for example about 0.1 wt %, about 0.2 wt %, about 0.3 wt %, about 0.4 wt %, about 0.5 wt %. For example, and without limitation, wt % of acid stabilizer in a sol-gel is about 0.5 wt % and a weight fraction of metal alkoxide is about 0.6 wt % or greater. As a further non-limiting example, a wt % of acid stabilizer in a sol-gel is about 0.3 wt % and a weight fraction of metal alkoxide is less than 0.6 wt %.

A ratio of metal alkoxide to acid stabilizer in a sol-gel can be from about 1:1 to about 3:1, such as about 2:1. A molar ratio of acid stabilizer to metal alkoxide can be from about 1:1 to about 40:1, such as from about 3:1 to about 8:1, such as from about 4:1 to about 6:1, such as from about 4:1 to about 5:1.

Without being bound by theory, it is believed that acid stabilizer in these ratios not only contributes to stabilizing a metal alkoxide for hydrolysis, but also protonates thiol moieties of a corrosion inhibitor, which reduces or prevents reaction of the corrosion inhibitor with, for example, a metal alkoxide.

Surfactant

Without wishing to be bound by theory, a surfactant useful to form sol-gels of the present disclosure provides enhanced adhesion of the sol-gel to the metal substrate by increasing surface wettability of the coating on the surface of the metal. The surfactant can enhance the adhesion and quantitated according to a wet cross hatch adhesion per ASTM D3359. For example, and without limitation, the sol-gel having the surfactant can increase the wet cross hatch adhesion to a value of 10.

Without wishing to be bound by theory, a surfactant useful to form sol-gels of the present disclosure provides enhanced adhesion of the sol-gel to the primer. Surfactants of the present disclosure can include a surfactant capable of performing an alkoxylation reaction, in which an addition of an epoxide to a substrate occurs. The surfactant can include one or more alcohol ethoxylates, alcohol propoxylates, ethoxysulfates, polethoxylated amines, or the like. For example, and without limitation, the surfactant can be ethylene-oxide alcohol, propylene-oxide alcohol, ethylene-oxide-propylene-oxide alcohol, polyethoxylated tallow amine, ethanolamine, diethanolamine, triethanolamine, or the like.

### Corrosion Inhibitor

A corrosion inhibitor useful to form sol-gels of the present disclosure provides corrosion resistance (to water) of the metal substrate disposed adjacent the sol-gel. Corrosion inhibitors of the present disclosure are compounds having one or more thiol moieties. Metal aircraft surfaces can comprise steel or an alloy having a major component, such as aluminum, and a minor component, known as an intermetallic. Intermetallics, for example, often contain copper metal which is prone to corrosion. Without being bound by theory, it is believed that the interaction of thiol moieties of a corrosion inhibitor of the present disclosure with copper-containing intermetallics on a metal surface (such as an aluminum alloy surface) prevents corrosion of the metal surface. More specifically, interaction of the thiol moieties of a corrosion inhibitor of the present disclosure with the intermetallics blocks reduction of the intermetallics by slowing the rate of oxygen reduction and decreasing oxidation of a metal alloy, such as an aluminum alloy.

A corrosion inhibitor of the present disclosure is an organic compound that includes a disulfide group and/or a thiolate group (e.g., a metal-sulfide bond). For example, the corrosion inhibitor is not an organometallic corrosion inhibitor. A corrosion inhibitor is represented by the formula: R¹—Sn—X—R², wherein R¹ is an organic group, n is an integer greater than or equal to 1, X is a sulfur or a metal atom, and R² is an organic group. One or both of R¹ and R² can include additional polysulfide groups and/or thiol groups. Furthermore, corrosion inhibitors include polymers having the formula —(R¹—Sn—X—R²)_{q}—, wherein R¹ is an organic group, n is a positive integer, X is a sulfur or a metal atom, R² is an organic group, and q is a positive integer. R¹ and R² (of a polymeric or monomeric corrosion inhibitor) is independently selected from H, alkyl, cycloalkyl, aryl, thiol, polysulfide, or thione. Each of R¹ and R² can be independently substituted with a moiety selected from alkyl, amino, phosphorous-containing, ether, alkoxy, hydroxy, sulfur-containing, selenium, or tellurium. Each of R¹ and R² has 1-24 carbon atoms and/or non-hydrogen atoms. For example, heterocyclic examples of R¹ and R² groups include an azole, a triazole, a thiazole, a dithiazole, and/or a thiadiazole.

A corrosion inhibitor includes a metal in a metal-thiolate complex. Corrosion inhibitors can include a metal center and one or more thiol groups (ligands) bonded and/or coordinated with the metal center with a metal-sulfide bond. A thiolate is a derivative of a thiol in which a metal atom replaces the hydrogen bonded to sulfur. Thiolates have the general formula M-S—R¹, wherein M is a metal and R¹ is an organic group. R¹ can include a disulfide group. Metal-thiolate complexes have the general formula M—(S—R¹)ₙ, wherein n generally is an integer from 2 to 9 and M is a metal atom. Metals are copper, zinc, zirconium, aluminum, iron, cadmium, lead, mercury, silver, platinum, palladium, gold, and/or cobalt.

The corrosion inhibitor includes an azole compound. Examples of suitable azole compounds include cyclic compounds having, 1 nitrogen atom, such as pyrroles, 2 or more nitrogen atoms, such as pyrazoles, imidazoles, triazoles, tetrazoles and pentazoles, 1 nitrogen atom and 1 oxygen atom, such as oxazoles and isoxazoles, and 1 nitrogen atom and 1 sulfur atom, such as thiazoles and isothiazoles. Nonlimiting examples of suitable azole compounds include 2,5-dimercapto-1,3,4-thiadiazole, 1H-benzotriazole, 1H-1,2,3-triazole, 2-amino-5-mercapto-1,3,4-thiadiazole, also named 5-amino-1,3,4-thiadiazole-2-thiol, 2-amino-1,3,4-thiadiazole. For example, and without limitation, the azole can be 2,5-dimercapto-1,3,4-thiadiazole. The azole can be present in the composition at a concentration of 0.01 g/L of sol-gel composition to 1 g/L of sol-gel composition, for example, 0.4 g/L of sol-gel composition. The azole compound can include benzotriazole and/or 2,5-dimercapto-1,3,4-thiadiazole.

Corrosion inhibitors of the present disclosure include heterocyclic thiol and amines, which can provide elimination of oxygen reduction. Heterocyclic thiols include thiadiazoles having one or more thiol moieties. Non-limiting examples of thiadiazoles having one or more thiol moieties include 1,3,4-thiadiazole-2,5-dithiol and thiadiazoles represented by formula (III) or formula (IV):

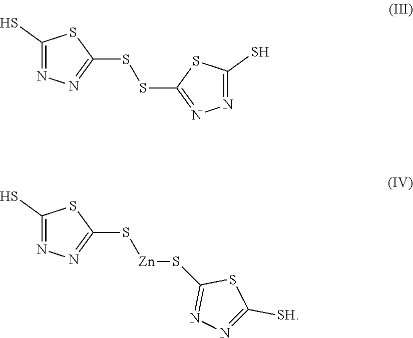

The thiadazole of formula (III) can be purchased from Vanderbilt Chemicals, LLC (of Norwalk, Connecticut) and is known as Vanlube® 829. The thiadiazole of formula (IV) can be purchased from WPC Technologies, Inc.™ (of Oak Creek, Wisconsin) and is known as InhibiCor™ 1000.

A corrosion inhibitor of the present disclosure can be a derivative of 2,5-dimercapto-1,3,4 thiadiazole symbolized by HS—CN₂SC—SH or “DMTD”, and of selected derivatives of trithiocyanuric acid (“TMT”) used for application as a corrosion inhibitor in connection with a paint. Examples include 2,5-dimercapto-1,3,4 thiadiazole (DMTD), and 2,4-dimercapto-s-triazolo-[4,3-b]-1,3-4-thiadiazole, and trithiocyanuric acid (TMT). Other examples include N—, S— and N,N—, S,S— and N,S-substituted derivatives of DMTD such as 5-mercapto-3-phenil-1,3,4-thiadiazoline-2-thione or bismuthiol II (3-Phenyl-1,3,4-thiadiazolidine-2,5-dithione) and various S-substituted derivatives of trithiocyanuric acid. Other examples include 5,5′ dithio-bis (1,3,4 thiadiazole-2(3H)-thione or (DMTD)₂, or (DMTD), the polymer of DMTD; 5,5′ thio-bis (1,3,4 thiadiazole-2(3H)-thione; or (TMT)₂, the dimer and polymers of TMT. Other examples include salts of DMTD of the general formula: M(DMTD)ₙ, where n=1, 2 or 3, and M is a metal cation such as M═Zn(II), Bi(III), Co(II), Ni(II), Cd(II), Pb(II), Ag(I), Sb(III), Sn(II), Fe(II), or Cu(II) (examples: ZnDMTD, Zn(DMTD)₂, Bi(DMTD)₃); similar salts of TMT, as for example, ZnTMT, in a ratio of 1:1; and, also, the comparable soluble Li(I), Ca(II), Sr(II), Mg(II), La(III), Ce(III), Pr(III), or Zr(IV) salts. Additional examples include salts of (DMTD)ₙ of general formula M[(DMTD)ₙ]m, where n=2 or n>2, m=1, 2, or 3 and M is a metal cation such as M═Zn(II), Bi(III), Co(II), Ni(II), Cd(II), Pb(II), Ag(I), Sb(III), Sn(II), Fe(II), or Cu(II). Typical examples are: Zn[(DMTD)₂], Zn[(DMTD)₂]₂.

Additional examples include ammonium-, aryl-, or alkyl-ammonium salts of DMTD, (DMTD)ₙ, or 5,5′ thio-bis (1,3,4 thiadiazole-2(3H)-thione or 2,4-dimercapto-s-triazolo-[4,3-b]-1,3-4-thiadiazole. Typical examples include: Cyclohexyl amine: DMTD, in ratios of 1:1 and 2:1; Di-cyclohexyl amine: DMTD, in ratios of 1:1 and 2:1; Aniline: DMTD, in ratios of 1:1 and 2:1; similar salts of TMT, as for example Di-cyclohexyl amine: TMT, in a ratio of 1:1. Additional examples include poly-ammonium salts of DMTD or (DMTD)ₙ and TMT formed with polyamines.

Additional examples include inherently conductive polyaniline doped with DMTD or (DMTD)₂ or 5,5′ thio-bis (1,3,4 thiadiazole-2(3H)-thione and TMT; Inherently conductive polypyrrole and/or polythiophene doped with DMTD, (DMTD)₂ and 5,5′ thio-bis (1,3,4 thiadiazole-2(3H)-thione and/or TMT.

Additional examples include micro or nano composites of poly DMTD/polyaniline, poly DMTD/polypyrrole, and poly DMTD/polythiophene; similar micro or nano composites with TMT; and with 5,5′ thio-bis (1,3,4 thiadiazole-2(3H)-thione; DMTD or salts of DMTD or derivatives of DMTD and of TMT, as organic constituents of various pigment grade inorganic matrixes or physical mixtures. Such inorganic matrixes can include non-toxic anionic and cationic species with corrosion inhibitor properties, such as: MoO₄⁻, PO₄⁻, HPO₃⁻, poly-phosphates, BO₂⁻, SiO₄⁻, NCN⁻, WO₄⁻, phosphomolybdate, phosphotungstate and respectively, Mg, Ca, Sr, La, Ce, Zn, Fe, Al, Bi.

Additional examples include DMTD or salts of DMTD or derivatives of DMTD and TMT in encapsulated forms, such as: inclusions in various polymer matrices, or as cyclodextrin-inclusion compounds or in microencapsulated form.

Pigment grade forms of DMTD include Zn(DMTD)₂ and Zn-DMTD (among other organic and inorganic salts of the former) with inorganic products or corrosion inhibitor pigments, such as: phosphates, molybdates, borates, silicates, tungstates, phosphotungstates, phosphomolybdates, cyanamides or carbonates of the previously specified cationic species, as well as oxides. Examples include: zinc phosphate, cerium molybdate, calcium silicate, strontium borate, zinc cyanamide, cerium phosphotungstate, ZnO, CeO₂, ZrO₂, and amorphous SiO₂.

A corrosion inhibitor is a lithium ion, and a counter ion, which can include various ions known to form salts with lithium. Non-limiting examples of counter ions suitable for forming a salt with lithium include carbonates, hydroxides and silicates (e.g., orthosilicates and metasilicates). For example, the corrosion inhibitor includes a lithium carbonate salt, a lithium hydroxide salt, or a lithium silicate salt (e.g., a lithium orthosilicate salt or a lithium metasilicate salt). The counter ion includes various ions known to form salts with the other Group IA (or Group 1) metals (e.g., Na, K, Rb, Cs and/or Fr). Nonlimiting examples of counter ions suitable for forming a salt with the alkali metals include carbonates, hydroxides and silicates (e.g., orthosilicates and metasilicates). For example, and without limitation, the corrosion inhibitor includes an alkali metal carbonate salt, an alkali metal hydroxide salt, and/or an alkali metal silicate salt (e.g. an alkali metal orthosilicate salt or an alkali metal metasilicate salt). For example, some nonlimiting examples of suitable salts include carbonates, hydroxides and silicates (e.g., orthosilicates or metasilicates) of sodium, potassium, rubidium, cesium, and francium.

Corrosion inhibitors of the present disclosure include aluminum and magnesium rich compounds, which can provide cathodic protection of a material. Aluminum rich corrosion inhibitors include aluminum or aluminum alloys, in which the aluminum or aluminum alloys are greater than 50 wt % by volume of the corrosion inhibitor. Magnesium rich corrosion inhibitors include magnesium or magnesium alloys, in which the magnesium or magnesium alloys are greater than 50 wt % by volume of the corrosion inhibitor. Corrosion inhibitors of the present disclosure can include Cesium compounds.

A weight fraction (wt %) of corrosion inhibitor by volume in the total sol-gel is from about 1 wt % to about 15 wt %, such as from about 3 wt % to about 15 wt %, such as from about 1 wt % to about 5 wt %, such as from about 5 wt % to about 10 wt %, such as from about 10 wt % to about 15 wt %, such as from about 12 wt % to about 15 wt %, for example about 1 wt %, about 5 wt %, about 10 wt %, about 15 wt %. For example, and without limitation, a wt % of corrosion inhibitor by volume in the total sol-gel is about 3 wt % to about 15 wt % and a weight fraction of metal alkoxide is about 0.6 wt % or greater by volume in the total sol-gel. As a further non-limiting example, a wt % of acid stabilizer by volume in the total sol-gel is about 3 wt % to about 15 wt % and a weight fraction of metal alkoxide in the sol-gel is less than 0.6 wt % by volume in the total sol-gel. The corrosion inhibitor incorporated into the sol-gel provides an additional layer of corrosion protection adjacent to the metal surface. Additionally, this will promote corrosion protection when used with non-chromate primer coating stackups.

### Primer

A primer of the present disclosure can be disposed on the sol-gel coating to enhance bond adhesion of aluminum surfaces and adhesion to subsequent epoxy primers. Primers of the present disclosure can be composed of a reactive polymer. For example, primers can be composed of an epoxy, e.g. an amine-cured epoxy. Primers of the present disclosure can be composed of a siloxane, e.g., a polysiloxane. Primers of the present disclosure can include about 0 to about 30 wt % of corrosion inhibitors by volume in the primer solution.

Primers of the present disclosure include organic primers having a plurality of metal particles capable of preventing fastener-induced corrosion and filiform corrosion. The metal particles can be sacrificial corrosion inhibits corrosion of the surface metal by undergoing oxidation prior to the surface metal. The metal particles can include an aluminum ion, and a counter ion, which can include various ions known to form salts with aluminum. Non-limiting examples of counter ions suitable for forming a salt with aluminum include carbonates, hydroxides and silicates (e.g., orthosilicates and metasilicates). For example, and without limitation, the counter ion includes an aluminum carbonate salt, an aluminum hydroxide salt, or an aluminum silicate salt (e.g., an aluminum orthosilicate salt or an aluminum metasilicate salt). The counter ion can include various ions known to form salts with the other Group 13 metals (e.g., B, Ga, In, Tl, Ho, and/or Es). Nonlimiting examples of counter ions suitable for forming a salt with the alkali metals include carbonates, hydroxides and silicates (e.g., orthosilicates and metasilicates).

The metal particles can include a magnesium ion, and a counter ion, which can include various ions known to form salts with magnesium. Non-limiting examples of counter ions suitable for forming a salt with magnesium include carbonates, hydroxides and silicates (e.g., orthosilicates and metasilicates). For example, and without limitation, the corrosion inhibitor includes a magnesium carbonate salt, a magnesium hydroxide salt, or a magnesium silicate salt (e.g., a magnesium orthosilicate salt or a magnesium metasilicate salt). The counter ion can include various ions known to form salts with the other Group 2 metals (e.g., Be, Ca, Sr, Ba, and/or Ra). Nonlimiting examples of counter ions suitable for forming a salt with the alkali metals include carbonates, hydroxides and silicates (e.g., orthosilicates and metasilicates).

The metal particles can include a lithium ion, and a counter ion, which can include various ions known to form salts with lithium. Non-limiting examples of counter ions suitable for forming a salt with lithium include carbonates, hydroxides and silicates (e.g., orthosilicates and metasilicates). For example, and without limitation, the corrosion inhibitor includes a lithium carbonate salt, a lithium hydroxide salt, or a lithium silicate salt (e.g., a lithium orthosilicate salt or a lithium metasilicate salt). The counter ion can include various ions known to form salts with the other Group IA (or Group 1) metals (e.g., Na, K, Rb, Cs, and/or Fr). Nonlimiting examples of counter ions suitable for forming a salt with the alkali metals include carbonates, hydroxides and silicates (e.g., orthosilicates and metasilicates).

A primer coating (disposed on the sol-gel) has a thickness of about 0.3 mils to about 2.5 mils, e.g., about 1.0 mils to about 2.0 mils, such as about 0.3 mils, about 0.5 mils, about 1.0 mils, about 1.5 mils, about 2.0 mils, about 2.5 mils, or the like.

### Top Coating

A top coat of the present disclosure can be disposed on the primer coating to form sol-gels of the present disclosure having corrosion resistance (to water) of the metal substrate disposed adjacent the sol-gel. The top coat can include an organic top coat such as a polymeric coating (e.g., an epoxy coating, and/or a urethane coating), a polymeric material, a composite material (e.g., a filled composite and/or a fiber-reinforced composite), a laminated material, or mixtures thereof. The top coating includes at least one of a resin, a thermoset polymer, a thermoplastic polymer, an epoxy, a lacquer, a polyurethane, a polyester, or combination(s) thereof. For example, and without limitation, the top coat is a polyurethane. The polyurethane top coat prevents water permeability through the coating to allow for increased corrosion protection. The top coat has a thickness of about 2 mils to about 3 mils, e.g., about 2.1 mils to about 2.9 mils, such as about 2 mils, about 2.1 mils, about 2.2 mils, about 2.3 mils, about 2.4 mils, about 2.5 mils, about 2.6 mils, about 2.7 mils, about 2.8 mils, about 2.9 mils, about 3 mils, or the like. For example, and without limitation, the top coat has a thickness of about 2 mils to about 3 mils and the primer has a thickness of about 0.3 mils to about 2.5 mils.

### Sol-Gel Systems

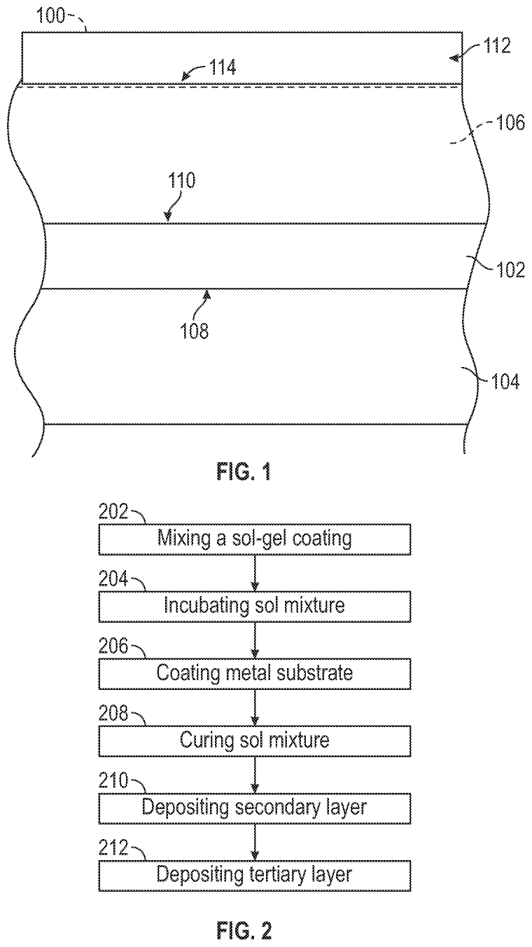

FIG. 1 is a side view of a corrosion-inhibiting sol-gel disposed on a substrate. A corrosion-inhibiting sol-gel system 100 includes a sol-gel 102 disposed on a material substrate 104. Sol-gel 102 has corrosion inhibiting properties which provide corrosion protection of material substrate 104. Sol-gel 102 promotes adherence between metal substrate 104 and a secondary layer 106. Secondary layer 106 can be a sealant, adhesive, primer or paint, which can be deposited onto sol-gel 102 by, for example, spray drying.

Material substrate 104 can be any suitable material described herein and/or can include any suitable structure that benefits from sol-gel 102 being disposed thereon. Material substrate 104 can define one or more components (such as structural or mechanical components) of environmentally exposed apparatuses, such as aircraft, watercraft, spacecraft, land vehicles, equipment, civil structures, fastening components, wind turbines, and/or another apparatus susceptible to environmental degradation. Material substrate 104 can be part of a larger structure, such as a vehicle component. A vehicle component is any suitable component of a vehicle, such as a structural component, such as landing gears, a panel, or joint, of an aircraft, etc. Examples of a vehicle component include a rotor blade, landing gears, an auxiliary power unit, a nose of an aircraft, a fuel tank, a tail cone, a panel, a coated lap joint between two or more panels, a wing-to-fuselage assembly, a structural aircraft composite, a fuselage body-joint, a wing rib-to-skin joint, and/or other internal component. Material substrate 104 can be made of at least one of aluminum, aluminum alloy, magnesium, magnesium alloy, nickel, iron, iron alloy, steel, titanium, titanium alloy, copper, and copper alloy, as well as glass/silica and other inorganic or mineral substrates. Material substrate 104 is made of steel. Material substrate 104 can be a ‘bare’ substrate, having no plating (unplated metal), conversion coating, and/or corrosion protection between material substrate 104 and sol-gel 102. Additionally or alternatively, material substrate 104 can include surface oxidization and/or hydroxylation. Hence, sol-gel 102 can be directly bonded to material substrate 104 and/or to a surface oxide layer on a surface of material substrate 104. The material is not water sensitive, but a sol-gel disposed on the material is capable of protecting other adjacent structures that might be water sensitive.

Secondary layer 106 is disposed on a second surface 110 of sol-gel 102 opposite first surface 108 of sol-gel 102. Sol-gel 102 has a thickness that is less than the thickness of material substrate 104. Sol-gel 102 has a thickness that is about 50 nm to about 4 μm, e.g., about 100 nm to about 2.5 μm, such as about 100 nm, about 200 nm, about 300 nm, about 400 nm, about 500 nm, about 600 nm, about 700 nm, about 800 nm, about 900 nm, about 1 μm, about 2 μm, about 2.5 μm, or the like. Thinner coatings can have fewer defects (more likely to be defect free), while thicker coatings can provide more abrasion, electrical, and/or thermal protection to the underlying material substrate 104.

Secondary layer 106 includes organic material (e.g., organic chemical compositions) configured to bind and/or adhere to sol-gel 102. Secondary layer 106 includes a paint, a primer, a top coat, a polymeric coating (e.g., an epoxy coating, and/or a urethane coating), a polymeric material, a composite material (e.g., a filled composite and/or a fiber-reinforced composite), a laminated material, or mixtures thereof. Secondary layer 106 includes at least one of a polymer, a resin, a thermoset polymer, a thermoplastic polymer, an epoxy, a lacquer, a polyurethane, and a polyester. Secondary layer 106 can additionally include at least one of a pigment, a binder, a surfactant, a diluent, a solvent, a particulate (e.g., mineral fillers), corrosion inhibitors, and fibers (e.g., carbon, aramid, and/or glass fibers).

Tertiary layer 112 is disposed on a proximal surface 114 of secondary layer 106 opposite second surface 110 of sol-gel 102. Tertiary layer 112 includes organic material (e.g., organic chemical compositions) configured to bind and/or adhere to secondary layer 106. Tertiary layer 112 includes a paint, a primer, a top coat, a polymeric coating (e.g., an epoxy coating, and/or a urethane coating), a polymeric material, a composite material (e.g., a filled composite and/or a fiber-reinforced composite), a laminated material, or mixtures thereof. Tertiary layer 112 includes at least one of a polymer, a resin, a thermoset polymer, a thermoplastic polymer, an epoxy, a lacquer, a polyurethane, and a polyester. Tertiary layer 112 can additionally include at least one of a pigment, a binder, a surfactant, a diluent, a solvent, a particulate (e.g., mineral fillers), corrosion inhibitors, and fibers (e.g., carbon, aramid, and/or glass fibers).

### Methods of Forming Sol-Gel

Methods of forming a sol-gel of the present disclosure include mixing a metal alkoxide, acetic acid, and an organic solvent, such as an anhydrous organic solvent, followed by stirring for from about 1 minute to about 1 hour, such as about 30 minutes. Additional organic solvent (e.g., from about 1 vol % to 20 vol % organic solvent to total volume, such as 5 vol %) is then added to the metal alkoxide/acetic acid mixture. An organosilane is then added to the mixture and stirred for from about 1 minute to about 1 hour, such as about 30 minutes. A corrosion inhibitor is added to the mixture in an amount of about 3 wt % of the corrosion inhibitor to the mixture to about 15 wt % of the corrosion inhibitor to the mixture. The mixture can be deposited onto a material substrate. The deposited mixture can be cured at ambient temperature or can be heated to increase the rate of curing/sol-gel formation.

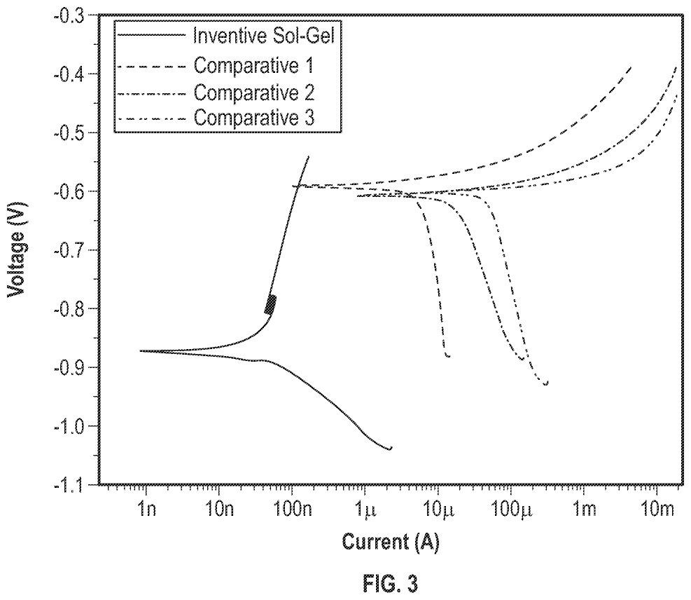

FIG. 2 is a flow chart illustrating a method 200 of forming a sol-gel 102. As shown in FIG. 2, sol-gel 102 can be formed by mixing 202 one or more sol-gel components. Sol-gel components include two or more of organosilane, metal alkoxide, acid stabilizer, and a corrosion inhibitor in an amount of about 3 wt % of the corrosion inhibitor to the sol-gel to about 15 wt % of the corrosion inhibitor to the sol-gel. Curing 208 the mixed components forms sol-gel 102.

Generally, mixing 202 is performed by combining the sol-gel formulation components (e.g., dispersing, emulsifying, suspending, and/or dissolving) in an organic solvent, preferably an anhydrous organic solvent, and optionally stirring the sol-gel formulation.

Mixing 202 includes mixing the sol-gel components to form a mixture (e.g., a solution, a mixture, an emulsion, a suspension, and/or a colloid). Mixing 202 includes mixing all sol-gel components together concurrently. Alternatively, mixing 202 includes mixing any two components (e.g., metal alkoxide and acid stabilizer in an organic solvent) to form a first mixture and then mixing the remaining components into the first mixture to form a second mixture. The first mixture and second mixture each have a water content from about 0.1 wt % of water to the mixture to about 10 wt % of water to the mixture, such as from about 0.1 wt % to about 5 wt %, such as from about 0.1 wt % to about 3 wt %, such as from about 0.1 wt % to about 1 wt %, such as about 0.1 wt % to about 0.5 wt %, such as 0.5 wt % or less, such as 0.3 wt % or less, such as 0.1 wt % or less, such as 0 wt %.

Mixing 202 can include dissolving, suspending, emulsifying, and/or dispersing the sol-gel components in an organic solvent before mixing with one or more of the other sol-gel components. Examples of solvents for dissolving, suspending, emulsifying, and/or dispersing sol-gel components include one or more of alcohol (e.g., ethanol or propanol), ethylene glycol, propylene glycol, polyethylene glycol, polypropylene glycol, ether (e.g., dimethyl ether or dipropylene glycol dimethyl ether), glycol ether, tetrahydrofuran (THF), N-methyl-2-pyrrolidone (NMP), and dimethyl sulfoxide (DMSO).

Additionally or alternatively, mixing 202 can include mixing one or more of the sol-gel components as a solid, an aggregate, and/or a powder with one or more of the other sol-gel components. Where, for example, mixing 202 includes mixing solids, powders, and/or viscous liquids, mixing 202 can include mixing with a high-shear mixer (e.g., a paint shaker or a planetary-centrifugal mixer or stirrer). A high-shear mixer can be advantageous to break and/or to finely disperse solids to form a substantially uniform mixture. For example, a high-shear mixer can dissolve, suspend, emulsify, disperse, homogenize, deagglomerate, and/or disintegrate solids into the sol-gel formulation.

The sol-gel components during mixing 202 can be diluted to control self-condensation reactions and thus increase the pot life of the mixed sol-gel formulation. Mixing 202 can include forming a weight percent (wt %) by volume of (metal alkoxide+organosilane+acid stabilizer to the mixture) in the mixture from about 0.1 wt % to about 30 wt %, such as from about 0.3 wt % to about 20 wt %, such as from about 1 wt % to about 10 wt %, such as from about 1 wt % to about 5 wt %, such as from about 2 wt % to about 4 wt %, such as from about 2 wt % to about 3 wt %, for example about 1 wt %, about 1.5 wt %, about 2 wt %, about 2.5 wt %, about 3 wt %.

Mixing 202 can include forming a weight percent (wt %) by volume of the corrosion inhibitor in the mixture from about 0.1 wt % to about 50 wt %, such as from about 0.2 wt % to about 40 wt %, such as from about 0.5 wt % to about 35 wt %, such as from about 1 wt % to about 30 wt %, such as from about 2 wt % to about 25 wt %, such as from about 3 wt % to about 15 wt %, for example about 4 wt %, about 5 wt %, about 7 wt %, about 10 wt, about 15 wt %. A sol-gel formulation contains a corrosion inhibitor and mixing 202 includes forming a weight percent (wt %) of (metal alkoxide+organosilane+acid stabilizer to the mixture) in the mixture from about 0.3 wt % to about 50 wt %, such as from about 1 wt % to about 45 wt %, such as from about 2 wt % to about 40 wt %, such as from about 3 wt % to about 35 wt %, such as from about 4 wt % to about 25 wt %, such as from about 8 wt % to about 22 wt %, for example about 10 wt %, about 12 wt %, about 15 wt %.

A volume ratio of organosilane to metal alkoxide in a sol-gel formulation during mixing 202 is from about 5% to about 20%, e.g., about 9% to about 11%, in which the metal alkoxide has been pretreated with an acid. For example, and without limitation, the volume ratio of organosilane to metal alkoxide is about 5%, about 6%, about 7%, about 8%, about 9%, about 10%, about 11%, about 12%, about 13%, about 14%, about 15%, about 16%, about 17%, about 18%, about 19%, about 20%, or the like. A higher ratio increases the % solids in the sol-gel coating and allows for a higher concentration of inhibitors to be mixed into the coating.

During mixing 202 the corrosion inhibitor can have 90% of the total particles in the mixture (D90) have diameters below a particle diameter of about 2 μm to about 5 μm, e.g., about 2 μm, about 3 μm, about 4 μm, or about 5 μm. The smaller particle sizes can allow for uniform mixing of the corrosion inhibitor within the mixture. A particle size as referenced herein may refer to average particle size. Average particle size may be determined in a commercially classified product, or by laser light scattering, according to several methods, for example ISO4406.

A mixture of sol-gel components can be incubated 204 for a period of time, such as from about 1 minute to about 60 minutes, such as from about 5 minutes to about 30 minutes, such as from about 10 minutes to about 20 minutes. Furthermore, pot-life is the period of time from the mixing until the sol-gel is formed (e.g., the mixture becomes too viscous to be usable). The pot life can be from about 1 hour to about 24 hours, such as from about 2 hours to about 8 hours, such as about 4 hours. Incubating 204 can be performed under ambient conditions (e.g., at room temperature) and/or at elevated temperature. Suitable incubation temperatures include from about 10° C. to about 100° C., such as from about 20° C. to about 70° C., such as from about 30° C. to about 50° C., for example about 40° C.

Method 200 includes coating 206 material substrate 104 with a mixture comprising sol-gel components and incubating 204 the mixture. Incubating 204 includes, after mixing the mixture comprising sol-gel components, allowing the mixture comprising sol-gel components to stand at room temp for about 30 minutes or more. Coating 206 can include wetting the material substrate 104 with a mixture comprising sol-gel components, for example, by spraying, immersing, brushing, and/or wiping the mixture comprising sol-gel components onto material substrate 104. For example, suitable forms of spraying include spraying with a spray gun, high-volume, low-pressure spray gun, and/or hand pump sprayer. The mixture comprising sol-gel components is allowed to drain from the wetted material substrate 104 for a few minutes (e.g., 1-30 minutes, 1-10 minutes, or 3-10 minutes) and, if necessary, excess, undrained mixture can be blotted off material substrate 104 and/or gently blown off material substrate 104 by compressed air.

Coating 206 includes cleaning and/or pretreating material substrate 104 before wetting the material substrate with the mixture comprising sol-gel components. The metal substrate can be pretreated by immersing the metal substrate into a solution maintained between pH 3.7-3.95 using 1N H₂SO₄ or 1N NaOH before applying the sol-gel coating. The solution can include about 3 grams/liter to about 22 grams/liter of water-soluble trivalent chromium salt, about 1.5 grams/liter to about 11.5 grams/liter of an alkali metal hexafluorozirconate, about 0 grams/liter (e.g., 0.1 grams/liter) to about 10 grams/liter of a water-soluble thickener, and about 0 grams/liter (e.g., 0.1 grams/liter) to about 10 grams/liter of a water-soluble surfactant selected from the group consisting of a non-ionic surfactant, anionic surfactant, cationic surfactant, and combinations thereof, per liter of the solution.

Generally, sol-gel 102 adheres and/or bonds better with a clean, bare material substrate, substantially free from dirt, nonreactive surface oxides, and/or corrosion products, and preferably populated with a sufficient concentration of reactive hydroxyl groups or other chemically-reactive species. Material substrate surface preparation methods can include degreasing, an alkaline wash, chemical etching, chemically deoxidizing, mechanically deoxidizing (e.g., sanding and/or abrading) and/or other suitable approaches towards creating a sol-gel compatible surface. Coating 206 does not typically include coating metal substrate 104 with an undercoating or forming a chemical conversion coating on metal substrate 104, unless the coating is applied to create a hydroxyl-rich substrate or otherwise improved compatibility with the sol-gel. A material substrate surface can become hydroxyl-rich by depositing silica hydroxylates onto the material surface.

Methods of the present disclosure include curing a mixture comprising sol-gel components. As shown in FIG. 2, curing 208 can include drying a mixture comprising sol-gel components disposed on material substrate 104 and can be performed under ambient conditions, at room temperature, and/or at elevated temperature. A curing temperature is from about 10° C. to about 150° C., such as from about 30° C. to about 100° C., such as from about 50° C. to about 90° C., for example about 60° C., about 70° C., about 80° C. Curing 308 can be performed for a period of time, such as from about 1 minute to about 48 hours, such as from about 5 minutes to about 24 hours, such as from about 10 minutes to about 8 hours, such as from about 30 minutes to about 4 hours, for example about 1 hour.

After coating 206 and/or curing 208, the sol-gel is suitable for exposure to an external environment and/or for application of a secondary layer 106. As shown in FIG. 2, depositing 210 a secondary layer 106 of organic material can be performed before curing 208 is completely finished, for example, depositing 210 a secondary layer 106 is performed at least partially concurrently with curing 208. Depositing 210 can include painting, spraying, immersing, contacting, adhering, and/or bonding sol-gel 102 with the organic material to form secondary layer 106. A secondary layer includes a primer, a paint, a fiber-reinforced plastic, or other suitable organic material.

After coating 210, the sol-gel is suitable for exposure for application of a tertiary layer 112. Depositing 212 can include painting, spraying, immersing, contacting, adhering, and/or bonding secondary layer 106 with the organic material to form tertiary layer 112. A tertiary layer includes a paint, a fiber-reinforced plastic, or other suitable organic material.

### EXAMPLES

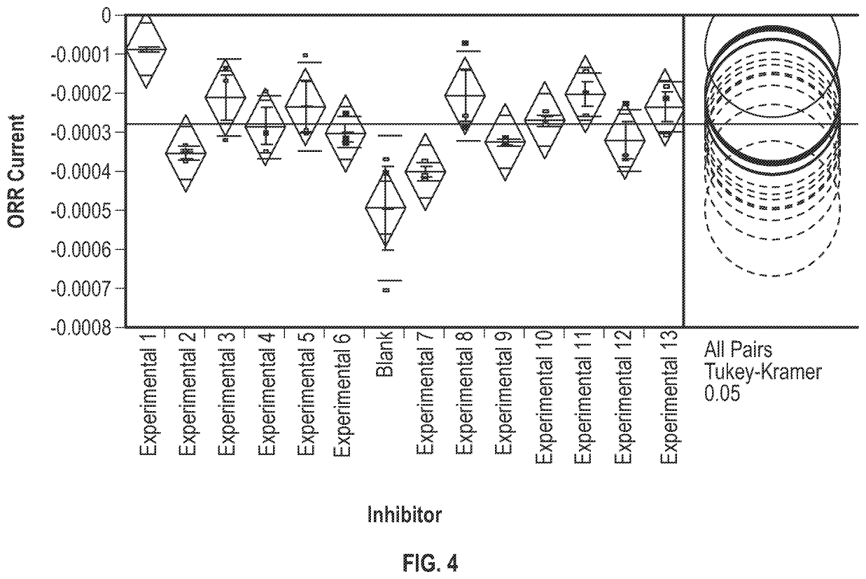

Now referring to FIG. 3 a potentiodynamic scan of the metal surface coated with a sol-gel pretreatment is displayed. Comparative 3 is a bare metal surface. Comparative 2 is a metal panel coated sol-gel film with 3 vol. % ingredients. Comparative 1 is a metal panel coated sol-gel film with >3% vol. % ingredients. Inventive sol-gel is a metal panel coated sol-gel film with >3 vol. % ingredients+corrosion inhibitor.

As the vol % of ingredients in the sol-gel increased, coating weight/coating thickness increased which increased the passivation of the film on the surface of the metal. This increased thickness caused a decrease in the corrosion current.

The inhibitor had cathodic inhibitive properties, causing a shift in potential towards negative values as well as a significant decrease in corrosion current.

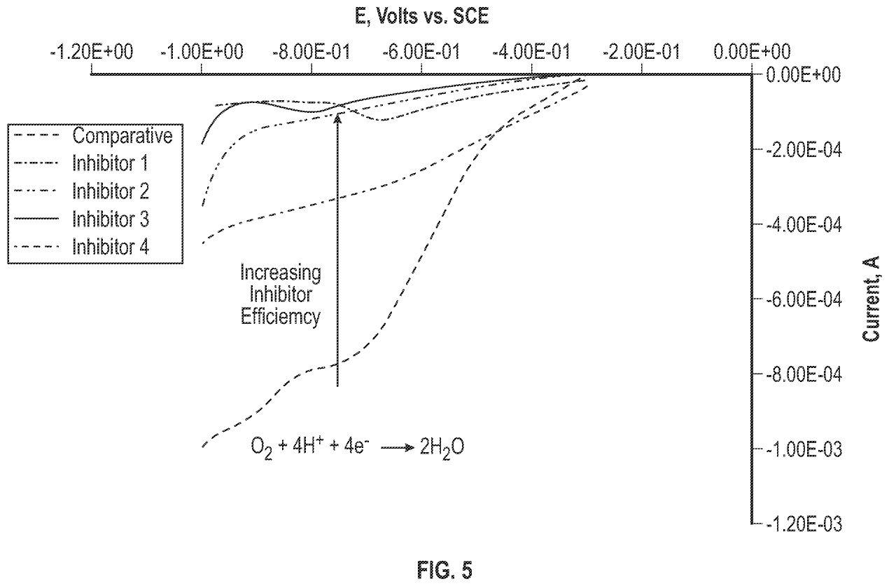

Now referring to FIG. 4, experimental 1 corrosion inhibitor, having 1,2,4 DMcT, provided the strongest corrosion inhibition compared to other organic or chromate inhibitors. Current values were monitored at −0.8V from potential-current scans of the inhibitor dissolved in electrolyte with metal surface as the working electrode. The current at the −0.8V was indicative of an oxidative reduction reaction occurring on the surface of the metal. The lower the ORR value the greater the action of the inhibitor, e.g., increased inhibitor efficiency.

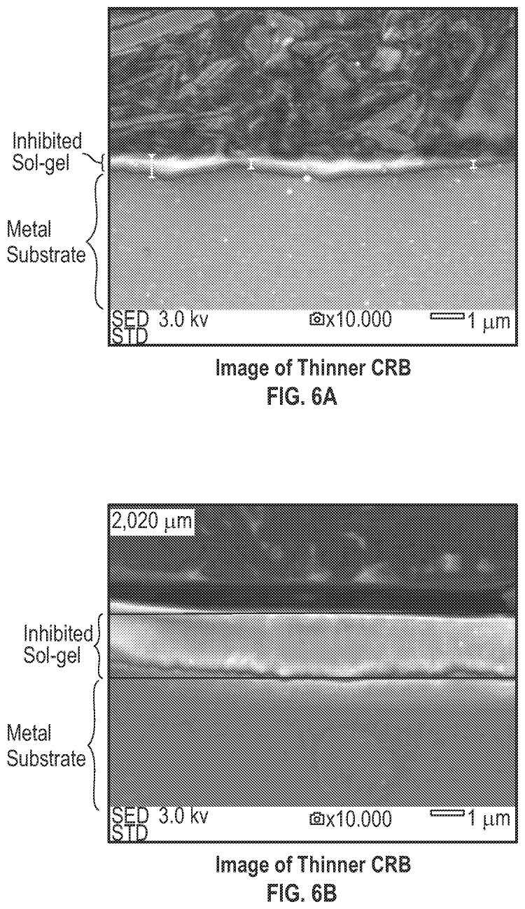

Now referring to FIG. 5, a current-voltage graph at the surface of the electrode is displayed. The current was −0.8V for the ORR on the surface of the metal. Without wishing to be bound by theory, suppression of the ORR current was assumed to be due to the inhibitor action, which is reaction of the inhibitor to the metal surface. Without wishing to be bound by theory, for thiol inhibitors, the inhibitor is commonly known to bind to copper rich sites on the surface of the metal alloy. Corrosion inhibition of inhibitor 1, inhibitor 2, inhibitor 3, and inhibitor 4, having about 3 wt % to about 15 wt % corrosion inhibitor exhibited better inhibitor efficiency compared to the comparative, having no corrosion inhibitor.

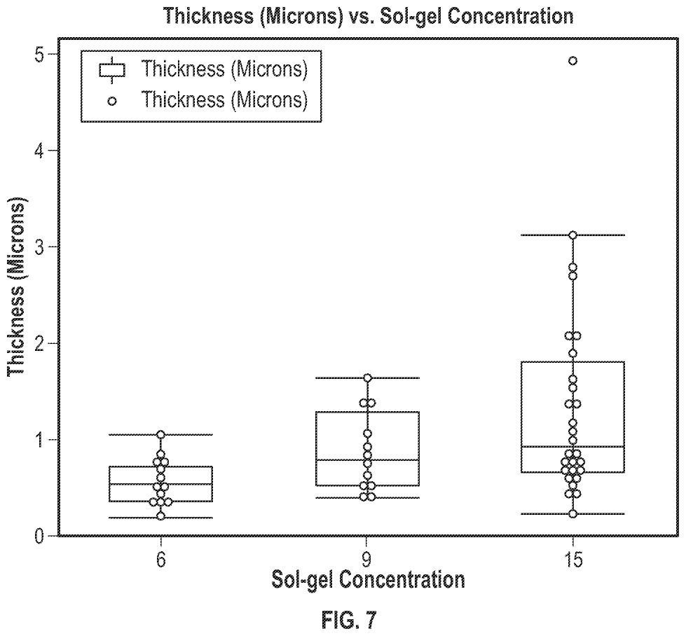

Now referring to FIGS. 6A and 6B, corrosion resistant sol-gels of the present disclosure can coat the metal substrate. The layer of corrosion resistant sol-gel can be thin, in which the thin layer can have fewer defects in the sol-gel, as shown in FIG. 6A. The layer of corrosion resistant sol-gel can be thick, in which an improved adhesion of sol-gel to material substrate, primer, or top coat, can occur, as shown in FIG. 6B.

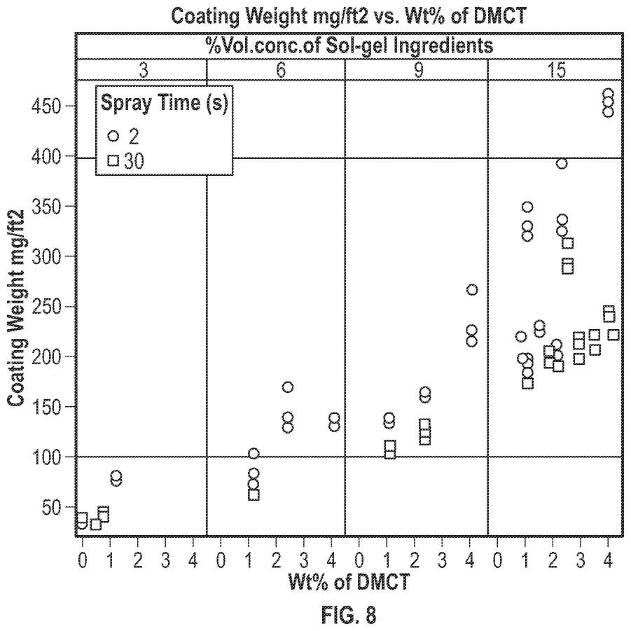

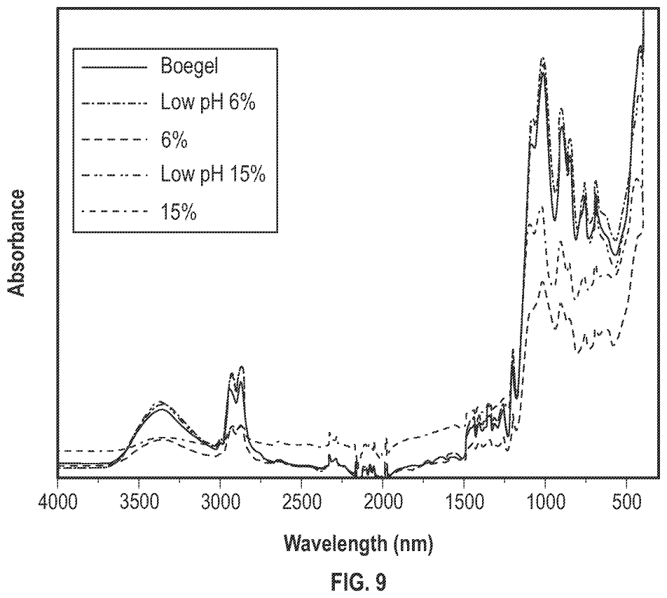

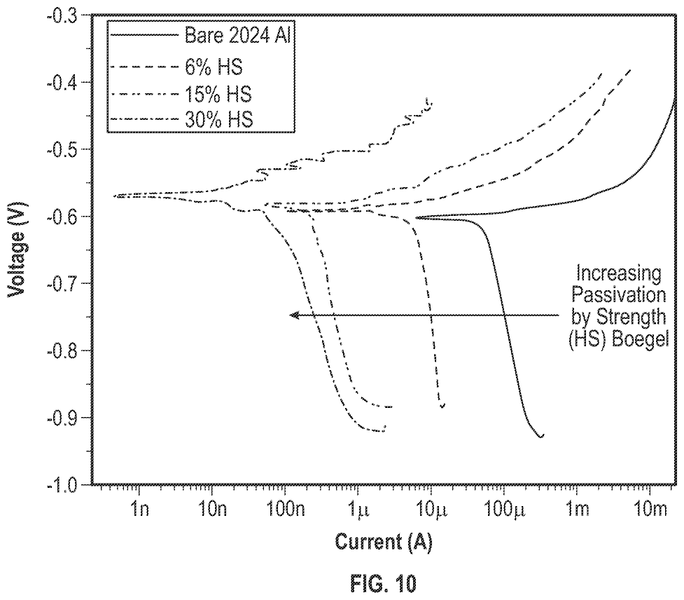

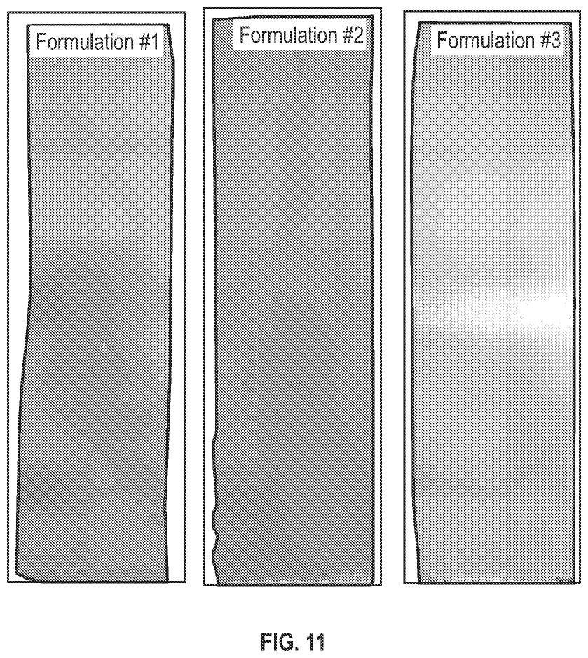

The average thickness of the sol-gels of the present disclosure was between 100 nm and 4 μm, as shown in FIG. 7. The average coating weight of the present disclosure was between 40 mg/ft² and 400 mg/ft², as shown in FIG. 8. The increasing sol-gel coating weight allowed for improved barrier properties, e.g., absorbance and passivation, as shown in FIGS. 9 and 10.

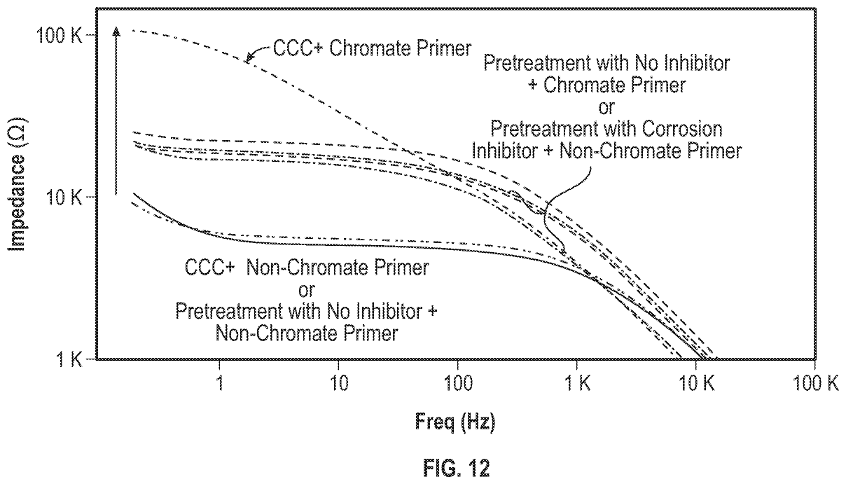

Now referring to FIG. 11, electrical contact resistances increased as the coating thickness and weight increased. 3 sample formulations of the corrosion resistant sol-gel were prepared, in which the vol % of ingredients in the sol-gel increased and a greater amount of inhibitor was added to the films when progressing from formulation #1 to formulation #2 to formulation #3. The increased vol % of sol-gel ingredients and inhibitor in the sol-gel, caused an increase in coating weight and thickness of the film. An improved corrosion resistance in the salt fog chamber occurred for formulation #1, when compared to formulation #1. However, as the film thickness increased the surface contact resistance values also increased.

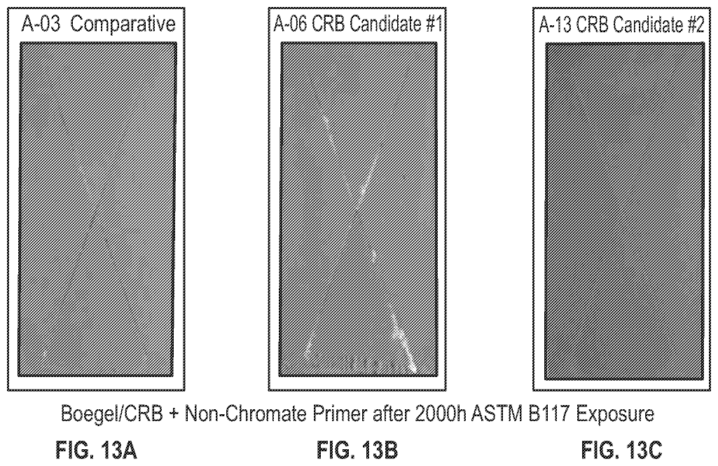

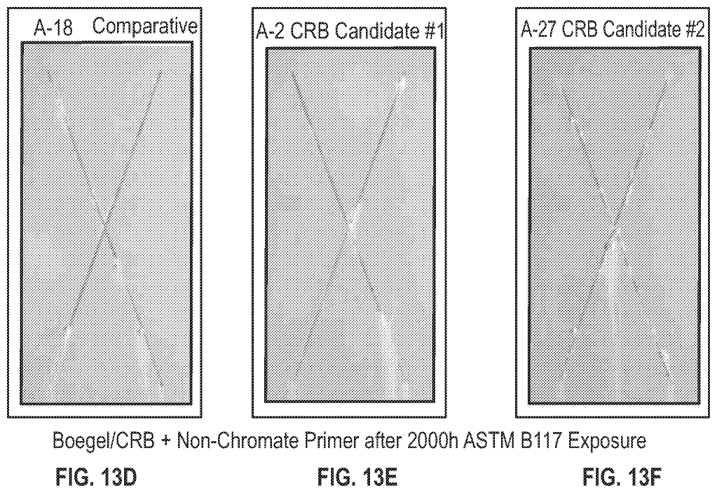

Now referring to FIG. 12, an impedance of coated panels as a function of frequency of applied AC current is depicted. A fully chromated stackup (chromated conversion coating (CCC)+chromated primer) had the highest impedance, while pretreatment with no inhibitor+chromate primer or pretreatment with inhibitor+non-chromate primer had intermediate impedance and finally a CCC+non-chromate primer or pretreatment with no primer and non-chromate primer had the lowest impedance. Without wishing to be bound by theory, adding an inhibitor to the pretreatment increased overall impedance of the film (synonymous with improved corrosion resistance) which improved performance of non-chromate primers. A reduction in corrosion occurred when coating a material substrate with the corrosion resistant sol-gel of the present disclosure compared to comparative sol-gels, as shown in FIGS. 13A-13F.

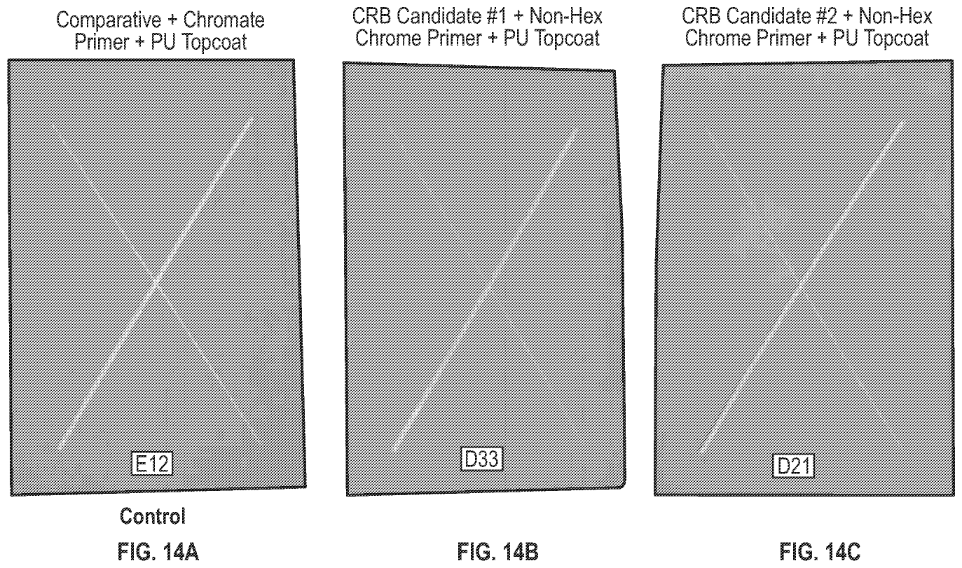

Corrosion resistance of the corrosion resistant sol-gel of the present disclosure having no chromates present, were comparable to sol-gels coated with a chromate corrosion inhibitor, as shown in FIGS. 14A-14C. Beach front coupons having 9 months of outdoor exposure were monitored for corrosion resistance. A chromated stack, as shown in FIG. 14A was compared to the corrosion resistant sol-gel pretreatment with non-chromate primer stacks, as shown in FIGS. 14B and 14C. Good corrosion resistance, with no blistering in the field and corrosion in the scribes was found for all coupons, as shown in FIGS. 14A-14C.

No effect on paint adhesion was found when coating a material substrate with the corrosion resistant sol-gels of the present disclosure, as shown in Table 1.

TABLE 1
Adhesion properties of sol-gel coated material substrate.

| | Comparative | Comparative | Inventive | Comparative | Comparative | Inventive |
|---|---|---|---|---|---|---|
| | 1 | 2 | 1 | 3 | 2 | 2 |
| | Chromate primer | | | Non- Chromate primer | | |
| Wet cross hatch | 10 | 10 | 10 | 10 | 10 | 10 |
| adhesion per BSS | | | | | | |
| 7225 Ty III, Cl 5 | | | | | | |
| Humidity Resistance | Pass | Pass | Pass | Pass | Pass | Pass |
| (120° F., 100% | | | | | | |
| R.H. for 30 days) | | | | | | |
| G.E. Reverse Impact | Fail | Pass | Pass | Fail | Pass | Pass |
| Testing per BSS 7225 | | | | | | |
| Skydrol Fluid | Pass | Pass | Pass | Pass | Pass | Pass |
| Resistance at R.T. | | | | | | |

### Preparation of Corrosion Resistant Sol-Gel

A part “A” solution was prepared by adding 22 mL glacial acetic acid (GAA, Fischer Scientific) to 50 mL zirconium propoxide (TPOZ, Acros Organics). Care was taken to ensure all glassware was completely dry to avoid Zirconium hydroxide formation. The resulting solutions were clear and light yellow in color. The solutions were left undisturbed for 10 min after which 1000 mL of Milli-Q water was added to it. This part A solution was used for all test matrices.

10.8 mL of glycidoxypropyltrimethoxy silane (GTMS, Acros Organics) was then added to 108 mL of the Part A in a Thinky™ planetary mixer container, mixed thoroughly and allowed to stand for 30 minutes. A 0.6 mL 10% volume aqueous solution of Antarox BL-204 (Solvay) in aqueous solution was then added followed by the addition of the inhibitor. 2 mm borosilicate glass beads were then added to the Thinky cup to cover the bottom. This solution was then blend mixed in the Thinky™ planetary mixer. (Step 1-30 s at 500 RPM, Step 2-30 s at 1000 RPM, Step 3-1 min at 1500 RPM).

Inhibitors Evaluated

Two inhibitors-HALOX® SZP-391 JM and HALOX® 430 JM were obtained from AICL advanced additives. Both inhibitors were jet milled materials with an average particle size of ˜3 microns and a D99 of ˜8 microns.

Inhibicor® 1000 and Hybricor® 204 were obtained from WPC technologies. Multiple versions of Inhibicor® 1000 were tested as described in the results and discussion section.

2,5-dimercapto-1,34-thiadiazole (DMCT) was obtained from Acros Organics; sodium benzoate and cerium nitrate from Sigma Aldrich. These compounds were used as received.

Panel Pre-Cleaning

All 7075-T6 panels were cleaned as follows: Degrease for 10 min in Brulin 815 GD followed by alkaline clean for 12 min in Bonderite C-AK and deoxidized for 10 min in Nitric/HF solution.

7178-T6 panels were grit blasted with 180 grit brown fused alumina to remove all residual coatings. The panels were then cleaned as described above for the 7075 panels.

Conversion Coating and Pretreatment Application

The various pretreatments and conversion coatings evaluated were SurTec 650V—a trichrome passivation from SurTec, Alodine 5900-a tri-chrome from Henkel, Alodine 1200S-hex-chrome conversion coating from Henkel and CORROSION RESISTANT SOL-GEL (−1 and −2).

The SurTec coating was applied using an immersion process. The solution was madeup using 5% vol. of the concentrate in aqueous solution. The solution was maintained between pH range of 3.7-3.95 using 1N H₂SO₄ or 1N NaOH. Cleaned panels were immersed in the SurTec 650V tank for 3 min followed by two to three rounds of 15-30 sec tap water rinse followed by a 15 sec deionized water rinse. The panels were then dried using compressed shop air. The coating was clear and translucent after drying.

The Alodine 5900 coating was brush applied onto the panels using the 5900 solution. To brush apply the coating, the cleaned panels were laid out on in a fume hood and the solution was brush applied, keeping the surface wet for 3 minutes. This was followed by two to three rounds of 15-30 sec tap water rinse and a 15 sec deionized water rinse. The panels were then dried in an oven at 100-120° F. for 1 h. The coating was clear with a bluish tint after drying.

The Alodine 1200S coating was brush applied onto the panels. To brush apply the coating, the cleaned panels were laid out in a fume hood and the solution was brush applied, keeping the surface wet for 3 minutes. This was followed by several rounds of 15-30 sec tap water rinse and a 15 sec deionized water rinse. The panels were then dried in an oven at 100-120° F. for 1 h. The coating had a golden hue after drying.

Corrosion resistant sol gel of the present disclosure was formulated and applied using a conventional HVLP gun followed by overnight drying at room temperature.

Primer and Topcoat Application

All primer and topcoat was applied the day after the panels were pretreated using the pretreatments described above. Both primers and topcoats were applied using a conventional HVLP gun. The topcoat was applied within a 4h window after application of the primer and the coatings were cured at room temperature for 2 weeks. After this two-week drying time, the panels were scribed using a wide tool cutter. Primer and topcoat thickness were measured from witness coupons sprayed concurrently with the panels. Primer and topcoat thicknessness were measured and recorded using a handheld Elcometer thickness gauge.

Test Matrices

The test matrices described below evaluated the several corrosion resistant sol-gel formulations per ASTM B117 and the new accelerated cyclic test method developed by BR&T4. BLIS 18-00512 compared the corrosion resistant sol-gel formulations to controls and trivalent chromium pretreatment alternatives. BLIS 18-00614 evaluated standalone corrosion resistance of a lower wt. % of DMCT and Inhibicor 1000 in aqueous solution. BLIS 18-00512-2 re-evaluated sol-gel systems described herein to 3000h exposure of ASTM B117.

Coating Stripping

Coating and Stripping

Bonderite Turco S-ST 5351, a methylene chloride based stripper was used to strip coatings from Test Matrix BLIS 18-00512-2. To strip the coatings, panels were immersed in the stripper overnight (some for ˜6 h). The efficiency of the stripper was recorded.

Inhibitor Screening in Corrosion Resistant Sol-Gel—Stand Alone Corrosion Protection

Several inhibitor chemistries were evaluated in the modified sol-gel formulation, as shown in Table 2.

TABLE 2
Inhibitors Screened for Stand-alone Protection
on 7075-T6, 24 Hour Exposure B117

| Inhibitor | Test | Result, Figure No. |
|---|---|---|
| HALOX SZP-391 | 24 hours ASTM B117 | Severe Corrosion |
| HALOX ® 430 JM | 24 hours ASTM B117 | Severe Corrosion |
| Hybricor ® 204 | 24 hours ASTM B117 | Minimal Corrosion |
| Inhibicor ® 1000 | 24 hours ASTM B117 | No Corrosion |
| DMcT | 24 hours ASTM B117 | No Corrosion |
| Sodium Benzoate | 24 hours ASTM B117 | Severe Corrosion |
| Cerium Nitrate | 24 hours ASTM B117 | Severe Corrosion |

When tested at a 2 wt. % loading of corrosion inhibitor to sol-gel the HALOX® SZP-391 JM containing corrosion-resistant sol-gel had better corrosion performance than the HALOX® 430 JM corrosion-resistant sol-gel. At 1.24 wt. % loading of corrosion inhibitor to sol-gel after 336 h exposure to NSS chamber resulted in corrosion inhibition. Some corrosion products, from aggregation of the inhibitor during drying, were visible on the lower parts of the panel. An improvement over the corrosion-resistant sol-gel formulation with the un-neutralized Inhibicor® 1000 (larger particle size) at 0.53 wt. % of corrosion inhibitor to sol-gel which had widespread corrosion after 120 h exposure to the NSS chamber occurred.

The corrosion-resistant sol-gel DMCT formulation was soluble in the modified sol-gel and had improved standalone corrosion resistance when tested at 1.24% wt. loading of corrosion inhibitor to sol-gel vs. 2.17 wt. % loading of corrosion inhibitor to sol-gel. At 1.24 wt %_DMCT, no corrosion products were visible after 336h standalone corrosion testing.

Evaluation of Aluminum and Lithium Rich primers on Corrosion-Resistant Sol-Gel Formulations

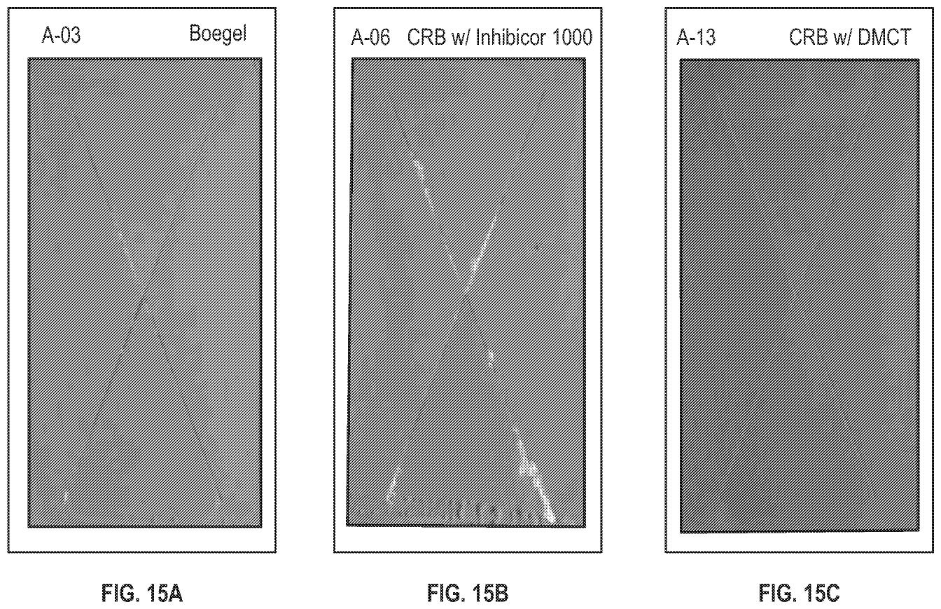

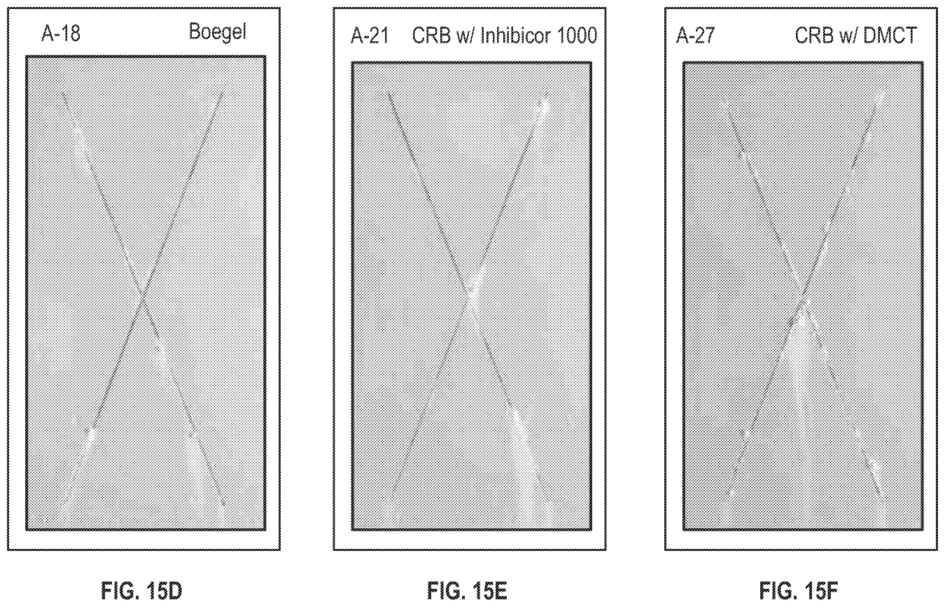

FIGS. 15A-15F show results from corrosion-resistant sol-gel with micronized un-neutralized Inhibicor® 1000 coated with the aluminum (A1)-rich (Av-dec) and lithium (Li)-rich primers (Akzo Nobel Aerodur 2118). After 2000h exposure to the NSS chamber, the panels with the A1-rich primers exhibited some blistering in the field, and both primers had white salt in the scribe.

The corrosion-resistant sol-gel containing DMCT also had exceptional corrosion performance after 2000h exposure to the NSS when coated with the A1-rich primer. The scribe was darkened, however did not have any corrosion products. When coated with the lithium rich primer, corrosion-resistant sol-gel containing DMCT exhibited poor corrosion resistance.

The corrosion-resistant sol-gel formulations with the micronized un-neutralized Inhibicor® 1000 and DMCT were further tested in novel accelerated salt spray corrosion testing developed by Chem Tech, BR&T in Seattle.

3000h ASTM B117 Corrosion Testing with Corrosion-Resistant Sol-Gel Formulations

7075-T6 Bare Panels

Alodine 1200S

Regardless of the pretreatment used, all the 7075-T6 panels coated with the primer RW-7171-64 had poor corrosion resistance with white salt and corrosion in the scribe and blistering in the field after 3000 h of NSS exposure. The blisters on panel A-1-1-3 only appeared after 2000h of exposure.

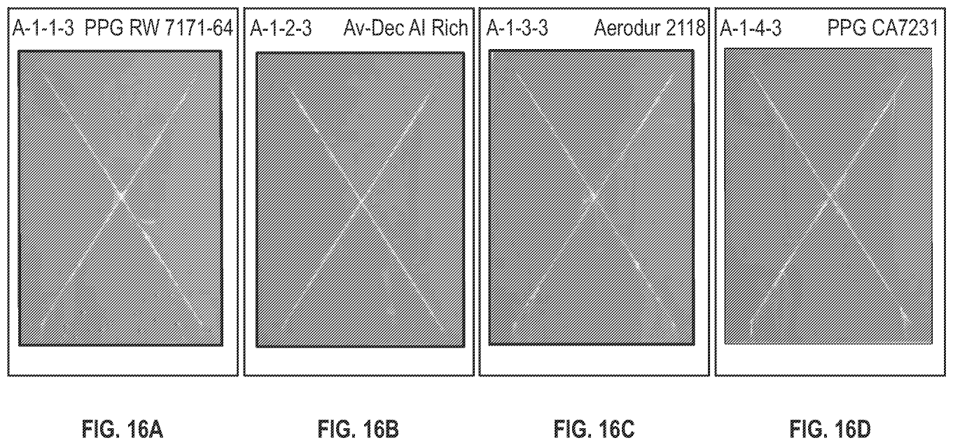

As shown in FIGS. 16A-16D, the 7075-T6 panels coated with Alodine 1200S performed well with the Aerodur 2118 and PPG CA7231 after 3000h of exposure. The panel with Alodine 1200S and the Li rich Aerodur 2118 had some blisters at the scribe. The scribe lines for all panels coated with Alodine had many localized sites of white salt in the scribe lines. After stripping the coatings from panels A-1-(1-4)-3, no corrosion was visible on any panels in the field, including under the small blisters for panel A-1-1-3. The Truco stripper had trouble stripping the A1-rich primer as is evident from panel A-1-2-1, the stripper also did not remove the Alodine conversion coating from any of the panels. The stripper stripped the Li— rich primer, and both PPG primers.

Alodine 5900

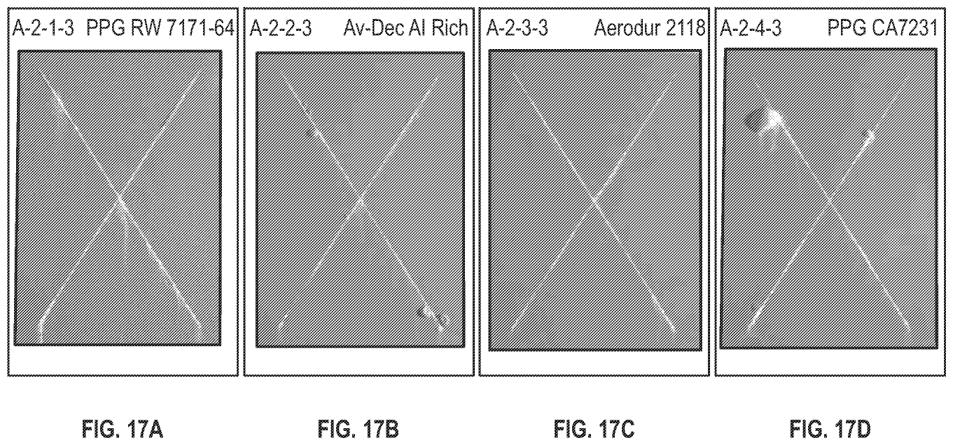

The tri-chromium pretreatment from Henkel Alodine 5900 had superior performance with Aerodur 2118 Li rich primer, as shown in FIGS. 17A-17D. The 7075-T6 panels with Av-Dec A1 rich and PPG CA7231 had blisters at the scribe. Almost the entire surface of Panel A-2-1-3 was covered small blisters.

Dark staining of the A1 was visible under the small blisters in the field from panel A-2-1-3. All of the large blisters on the scribe had evidence of pitting under the coating. Blisters on panels A-2-1-3 and A-2-4-3 appeared after 1000h of NSS exposure.

The Turco stripper could not strip the Li rich primer from Panels A-2-3-(1-2), but was able to strip the PPG and Av-Dec primers.

SurTec 650V

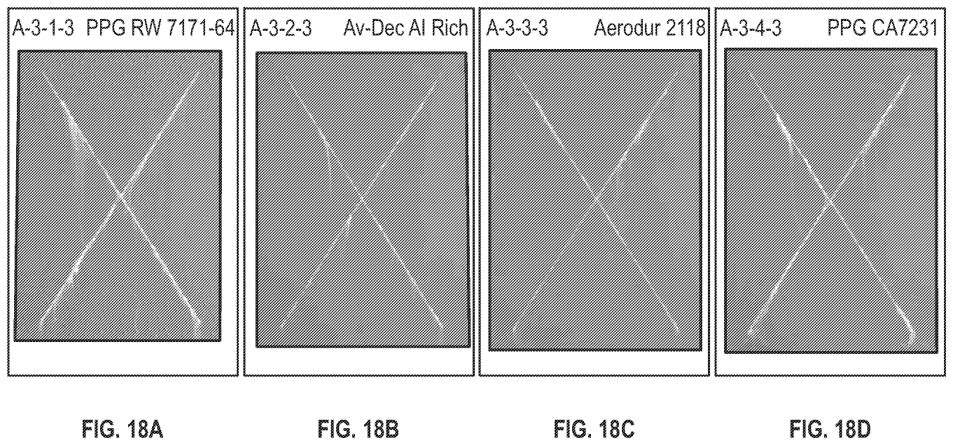

Now referring to FIGS. 18A-18D, the SurTec 650V exhibited corrosion resistance and compatibility with the Av-Dec, Aerodur 2118 and CA7231 primers. After 3000h of exposure none of these panels had any blisters in the field, however small blisters and pitting corrosion was observed on the scribe underneath the coating for the Av-Dec and CA7231 primers. The surface of Panel A-3-1-3 was covered with small blisters after 2000 h of NSS exposure, however there was no evidence of corrosion under the blisters.

All blisters on panels A-3-(1-4)-3 appeared after 2000h of NSS exposure. With the exception of the Aerodur 2118, the other primers were stripped with the Turco stripper.

Corrosion Resistant Sol-Gel

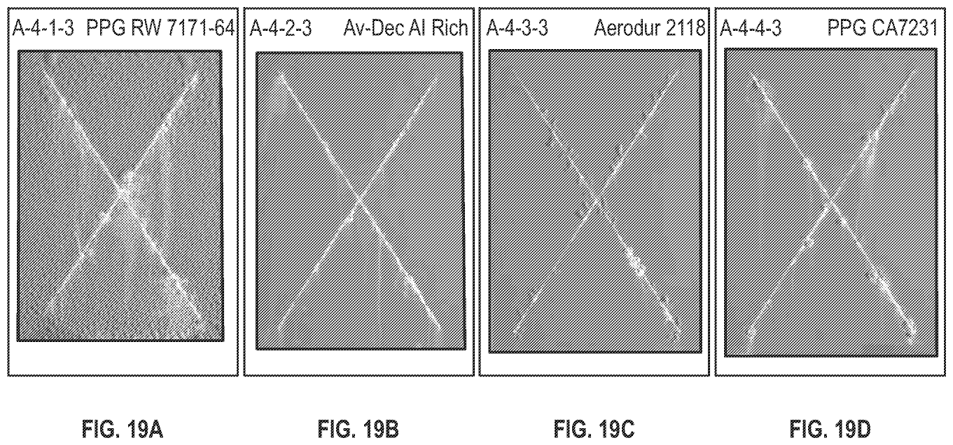

Now referring to FIGS. 19A-19D, the corrosion resistant sol-gel pretreatment exhibited corrosion resistance with the Av-Dec A1-rich primer. The panels with corrosion resistant sol-gel and Aerodur 2118 and CA7231 had large blisters and white salt in the scribes. The A-4-1-3 panel with the RW7171-64 coating had severe blistering in the field and in the scribe.

Blistering on the scribe for all panels coated with corrosion resistant sol-gel-2 pretreatment was visible after 1000h of NSS exposure, this blistering and corrosion worsened with increased exposure. The Turco stripper did a poor job stripping the primers from panels with the corrosion resistant sol-gel-2 pretreatment. After stripping the primer from panels A-4-(1-4)-3 it was evident that there was no corrosion underneath blisters observed in the field, however the blisters adjacent to the scribe had pitting corrosion underneath the paint.

7178 Panels

Alodine 1200S

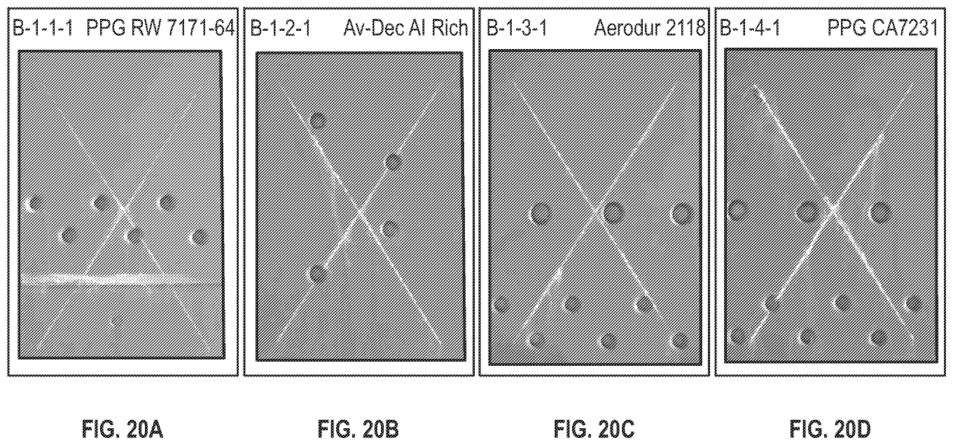

Panels with the Alodine 1200S chromate corrosion inhibitor exhibited corrosion performance with the RW-7171-64 primer and the Aerodur 2118 primer. Panels with Alodine 1200S and Av-Dec had some white salt in the scribe, while the primer CA7231 had some blisters under the primer along the scribe, and lots of white salt in the scribe, as shown in FIGS. 20A-20D.

None of the primers stripped well from panels B-1-(1-4)-1 with the Truco stripper. Blisters on the scribe had pitting corrosion underneath the paint.

Alodine 5900

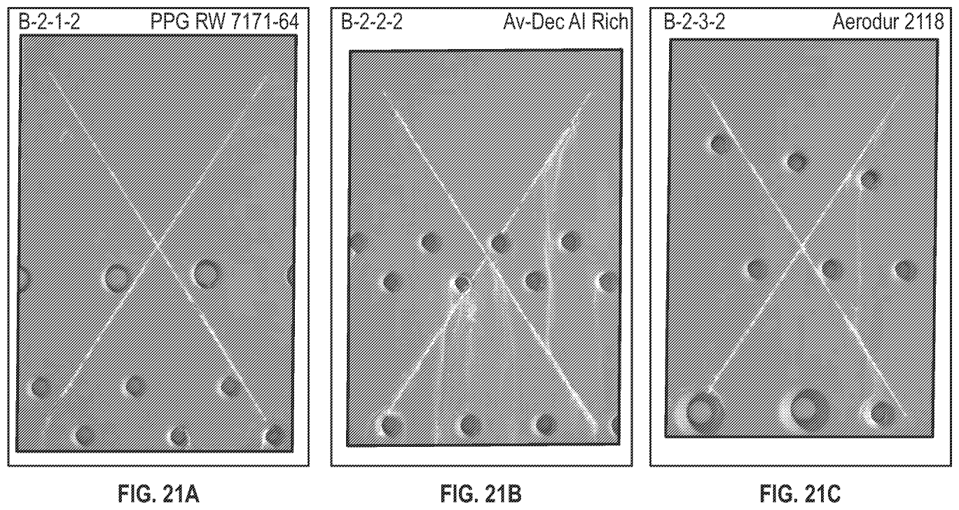

Now referring to FIGS. 21A-21C, both the Aerodur 2118 and RW7171-64 coated panels had minimal salt in the scribe, and creepage. The panels coated with the Av-Dec A1-rich primer had salt in the scribe and some blistering under the primer along the scribe. When the coating was removed from these panels, pitting corrosion was visible underneath the blisters along the scribe.

The Truco stripper did not strip panels B-2-1-(1-2) with the PPG RW-7171-64 primer. The A1 rich primer after 1500 h of exposure was removed with the stripper, however the primer did not strip after 3000h of exposure.

SurTec 650V

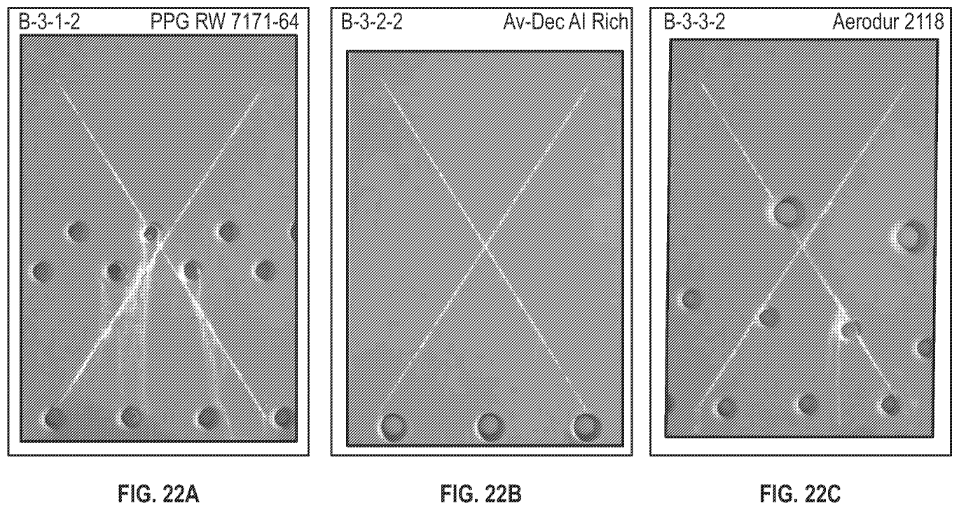

Now referring to FIGS. 22A-22C, SurTec 650V with the Av-Dec A1 rich primer had minimal salt in the scribe and no blistering on the panels. Panels coated with Aerodur 2118 had salt in the scribe, and RW7171-64 had salt in the scribe and some blistering along the scribe. Pitting corrosion was evident underneath blistering on the scribe on these panels. The RW-7171-64 and Av-Dec A1-rich primer was not removed with the Truco stripper.

Corrosion Resistant Sol-Gel-2

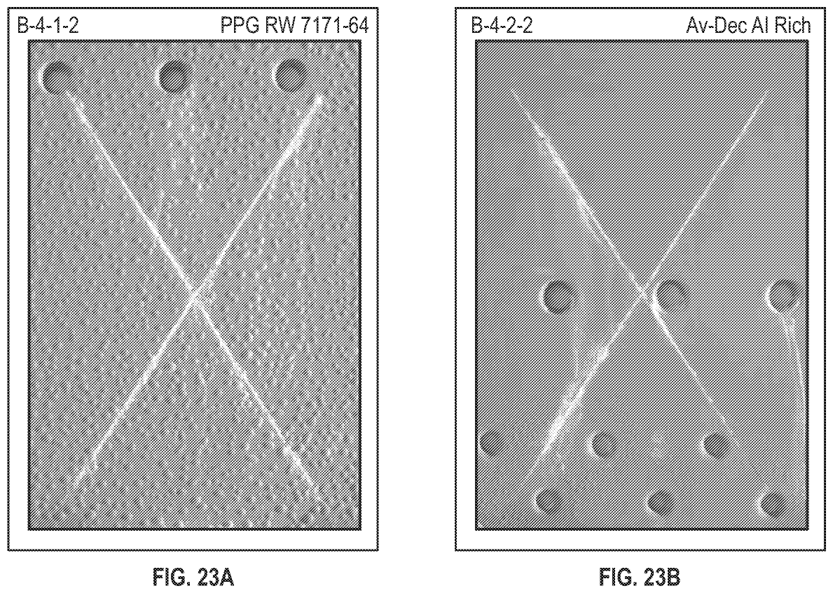

Now referring to FIGS. 23A and 23B, the corrosion resistant sol-gel coated panels with the Av-Dec A1 rich primer had small blisters. There was salt in the scribe and some blistering along the scribe line. No corrosion was visible underneath the blisters in the field while blisters adjacent to the scribe had pitting corrosion underneath the primer for panel B-4-2-2.

The corrosion resistant sol-gel coated panels with RW 7171-64 primer exhibited ˜ 1/16th″ blisters, and had white salt and blistering in the scribe. However, only the blisters on the scribe had pitting corrosion underneath the primer, none of the blisters in the field had corrosion underneath the primer.

The Truco stripper did not strip the primers on these panels with the corrosion resistant sol-gel-2 pretreatment.

Ranking of 7075-T6 and 7178 A1 Panels after NSS Corrosion Testing

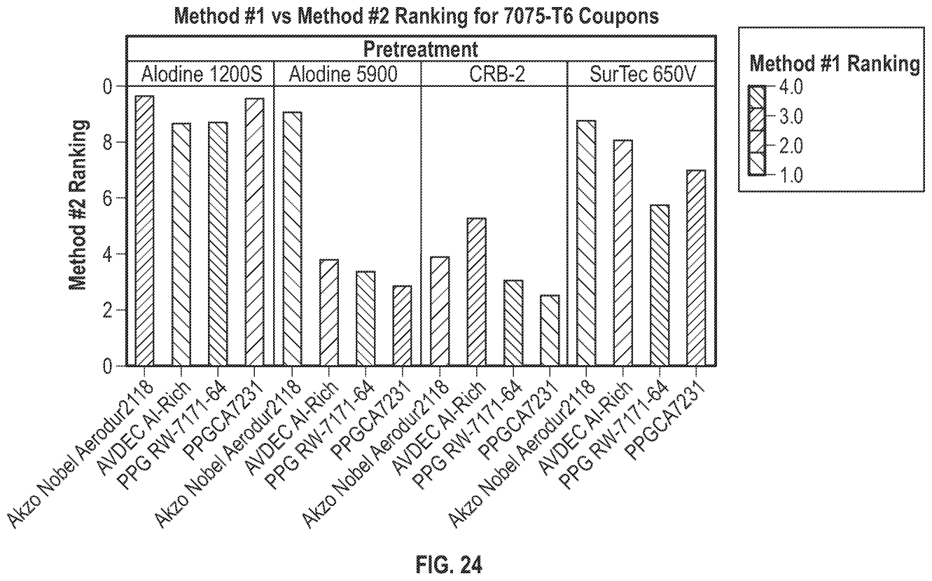

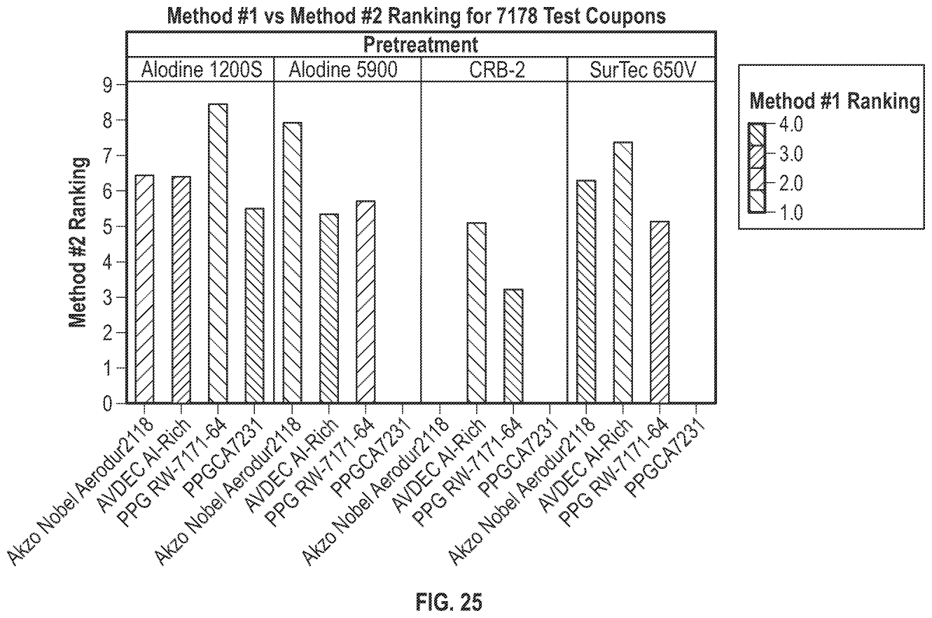

Now referring to FIGS. 24 and 25, ranking of the coated 7075-T6 and 7178 A1 panels after corrosion testing was performed using Methods #1 and #2 described below.

Method #1 Ranking

A panel was given a numerical rank based on its corrosion performance as compared to corrosion performance of other panels within a set.

Each panel was rated from 1-15, as shown in Table 3, based on scribe line appearance, amount of white salt (corrosion products) in the scribe, blisters along the scribe line and blisters away from the scribe line. Scribe line ratings were based on the creepage from the scribe line measured in inches, as shown in Table 4.

Panels within a group containing the same pretreatment (and different primers) were ranked numerically from 1 to 2, 3 or 4 with 1 being the best candidate and 4 being the worst. The 7075-T6 A1 panels were assessed after 1000h, 2000h, and 3000h of exposure and the 7178 panels were assessed after 1500h and 3000h of exposure.

SurTec 650V panels coated with Aerodur 2118, AvDec PT27703, AvDec GK15-002E1, and PPG CA7231 exhibited corrosion resistance properties up to 9 months after application. Corrosion resistant sol-gels of the present disclosure coated with AvDec GK15-002E1 exhibited corrosion resistance properties up to 9 months after application.

TABLE 3
Corrosion rating determination for Method #1

| Corrosion Rating | Description |
|---|---|
| 1 | Scribe line beginning to darken or shiny scribe |
| 2 | Scribe lines greater than 50% darkened |
| 3 | Scribe line dark |
| 4 | Several localized sites of white salt in scribe |
| | lines |
| 5 | Many localized sites of white salt in scribe |
| | lines |
| 6 | White salt filing scribe lines |
| 7 | Dark corrosion sites in scribe lines |
| 8 | Few blisters under primer along scribe line |
| | (<12) |
| 9 | Many blisters under primer along scribe line |
| 10 | Slight lift along scribe lines |
| 11 | Coating curling up along scribe |
| 12 | Pin point sites/pits of corrosion on organic |
| | coating surface ( 1/16″ to ⅛″ dia.) |
| 13 | One or more blisters on surface away from |
| | scribe |
| 14 | Many blisters under primer away from scribe |
| 15 | Starting to blister over surface |

TABLE 4
Scribe line rating determination for Method #1.

| Scribe Line Rating | Description |
|---|---|
| A | No Creepage |
| B | 0 to 1/64″ |
| C | 1/64″ to 1/32″ |
| D | 1/32″ to 1/16″ |
| E | 1/16″ to ⅛″ |
| F | ⅛″ to 3/16″ |
| G | 3/16″ to ¼″ |
| H | ¼″ to ⅜″ |

Method #2 Ranking

Each panel was assigned an independent score, regardless of performance of other panels within the test matrix. Method #2 score/rank was determined using 3 factors, 1) General corrosion (GC) rating, 2) blister size (BS) rating and 3) blister frequency (BF) rating. Each 7075-T6 panel that completed 1000h, 2000, and 3000h of exposure was assigned a numerical value for each of the 3 criteria and a total score was calculated using the equation (1) below.

A weighting was applied to the score determined at each interval such that the score at larger exposure times was weighted more heavily, according to equation 1 below. The 1000h score was multiplied by 0.2, the 2000h score was multiplied by 0.3 and the 3000h score was multiplied by 0.5. These weighted scores were then added together and the sum was divided by 2 to provide the final Method #2 score for each panel.

Method #2 overall score=((((BS score₁₀₀₀ₕ*BF score₁₀₀₀ₕ)+GC score₁₀₀₀ₕ)*0.2)+(((BS score₂₀₀₀ₕ*BF score₂₀₀₀ₕ)*0.3)+(((BS score₃₀₀₀ₕ*BF score₃₀₀₀ₕ)+GC score₃₀₀₀ₕn)*0.5))*0.5 Equation (1)

The general corrosion rating was determined based on observable pitting corrosion around the scribe and in the field on a stripped panel. Panels with minimal corrosion was assigned the highest value of 10 while panels with the most severe corrosion was assigned the lowest value of 2.

For blister size and frequency, scoring was assigned based on the size and density of blistering observed both in the field and on the scribe of the coated panel. Panels with no blistering was assigned a blistering frequency score of 1.

The composite score weighting scheme for 7178-T6 panels was modified due to only two intervals (at 1500h and 3000h) instead of three (1000h, 2000h and 3000h) as was the case in 7075-T6.

For 7178-T6 panels the score after 1500h of exposure was multiplied by 0.33 and the score after 3000h of exposure was multiplied by 0.67. As previously, these two scores were added together and the sum was divided by 2 to provide the final score.

The same criteria for determination of blister size and blister frequency were applied for the 7178 panels as for the 7075-T6 panels.

Comparison of Corrosion Resistance of Coated 7075-T6 and 7178 A1 Panels after NSS and Cyclic Accelerated Corrosion Testing

The Method #2 scoring allowed for comparison of corrosion performance of similar coating stack-ups between two different accelerated corrosion tests.

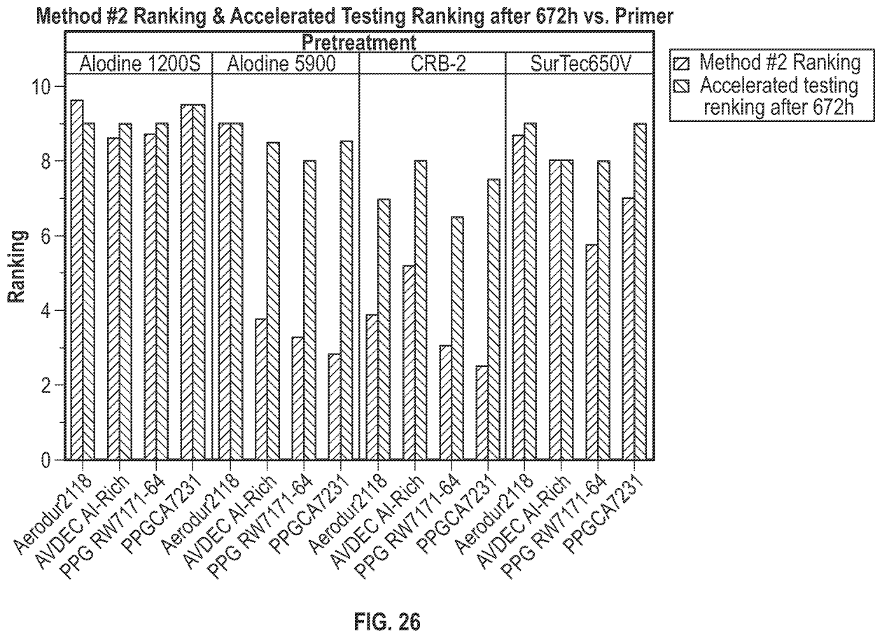

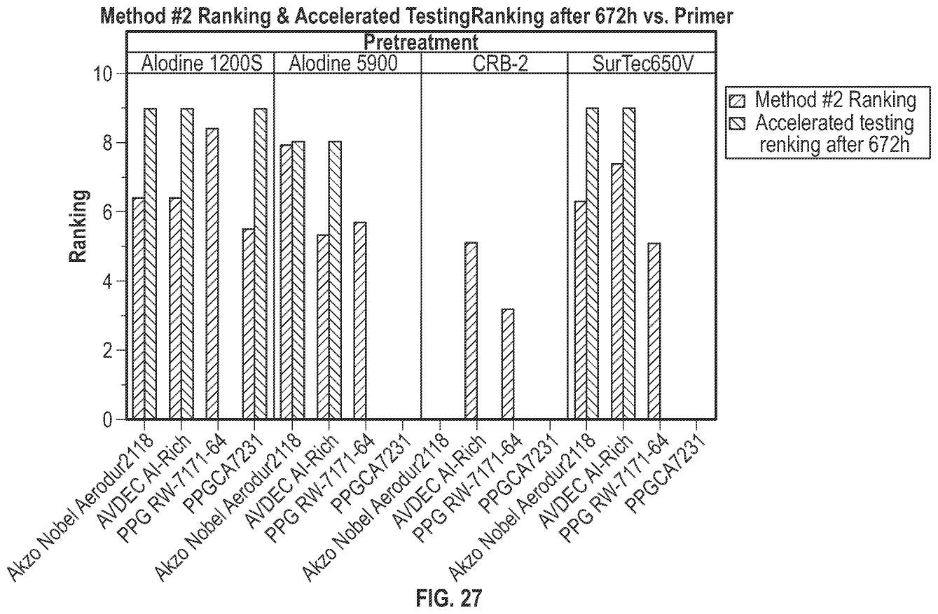

Now referring to FIGS. 26 and 27, an extreme difference in performance was observed for the corrosion resistant sol-gel-2 containing paint stack-up. The corrosion resistant sol-gel-2/Av-Dec A1 rich coating provided corrosion resistance under the cyclic accelerated corrosion test conditions, but not with the ASTM B117 testing.

A similar effect was observed for Magnesium (Mg) rich primers after ASTM B117 testing. It was observed that Mg-rich primers exhibited corrosion resistance on outdoor exposure and actual test conditions but not in accelerated corrosion testing (per ASTM B117 conditions). A passive MgCO₃ layer formed in the outdoor exposure that provided both anodic and cathode corrosion protection. However, in the exposure to ASTM B117 conditions resulted in formation of thin and porous Mg(OH)₂ layer with lower corrosion performance.

### Additional Aspects

The present disclosure provides, among others, the following aspects, each of which may be considered as optionally including any alternate aspects.

Clause 1. A coated substrate, comprising:
a metal substrate; and
a sol-gel coating disposed on the metal substrate, the sol-gel coating comprising a sol-gel comprising:
   about 3 wt % to about 15 wt % of an organic corrosion inhibitor,
   a surfactant, and
   a reaction product of an epoxy-containing organosilane, a metal alkoxide, and an acid.

Clause 2. The coated substrate of Clause 1, further comprising an organic primer coating comprising an organic primer disposed on the sol-gel coating.

Clause 3. The coated substrate of Clauses 1 or 2, wherein the organic primer coating further comprises a plurality of metal particles.

Clause 4. The coated substrate of any of Clauses 1 to 3, wherein the metal is a combination of:
aluminum, a salt of aluminum, or a cation of aluminum, and
magnesium, a salt of magnesium or a cation of magnesium.

Clause 5. The coated substrate of any of Clauses 1 to 4, wherein the organic primer is a polysiloxane or an epoxy.

Clause 6. The coated substrate of any of Clauses 1 to 5, wherein the epoxy is an amine-cured epoxy.

Clause 7. The coated substrate of any of Clauses 1 to 6, wherein the surfactant is an ethylene-oxide alcohol, a propylene-oxide alcohol, or an ethylene-oxide-propylene-oxide alcohol.

Clause 8. The coated substrate of any of Clauses 1 to 7, further comprising an organic topcoat disposed on the primer coating.

Clause 9. The coated substrate of any of Clauses 1 to 8, wherein the organic topcoat is a polyurethane.

Clause 10. The coated substrate of any of Clauses 1 to 9, wherein the organic topcoat has a thickness of about 2 mils to about 3 mils and the organic primer coating has a thickness of about 0.3 mil to about 2.5 mils.

Clause 11. The coated substrate of any of Clauses 1 to 11, wherein the organic corrosion inhibitor has two or more thiol moieties.

Clause 12. The coated substrate of any of Clauses 1 to 11, wherein the organic corrosion inhibitor is a mercaptothiadiazole.

Clause 13. The coated substrate of any of Clauses 1 to 12, wherein the dimercaptothiadiazole is 2,5-dimercapto-1,3,4-thiadiazole.

Clause 14. The coated substrate of any of Clauses 1 to 13, wherein the metal substrate is an aluminum substrate.

Clause 15. The coated substrate of any of Clauses 1 to 14, wherein the aluminum substrate is a 7075-T6 aluminum substrate or a 7178 aluminum substrate.

Clause 16. The coated substrate of any of Clauses 1 to 15, wherein the sol-gel coating has a thickness of about 50 nm to about 4 microns.

Clause 17. The coated substrate of any of Clauses 1 to 17, wherein the sol-gel coating has a thickness of about 100 nm to about 2.5 microns.

Clause 18. The coated substrate of any of Clauses 1 to 17, wherein the sol-gel coating has a weight of about 30 mg/ft² to about 400 mg/ft².

Clause 19. The coated substrate of any of Clauses 1 to 18, wherein the sol-gel coating has a weight of about 250 mg/ft² to about 1000 mg/ft², such as about 250 mg/ft² to about 350 mg/ft².

Clause 20. The coated substrate of any of Clauses 1 to 19, wherein the sol-gel coating has a concentration of the organic corrosion inhibitor of about 5 wt % to about 10 wt %.

Clause 21. The coated substrate of any of Clauses 1 to 20, wherein the sol-gel coating has a concentration of the organic corrosion inhibitor of about 10 wt % to about 15 wt %.

Clause 22. The coated substrate of any of Clauses 1 to 21, wherein the sol-gel coating has a concentration of the organic corrosion inhibitor of about 12 wt % to about 15 wt %.

Clause 23. The coated substrate of any of Clauses 1 to 22, wherein the organic corrosion inhibitor is not an organometallic corrosion inhibitor.

Clause 24. The coated substrate of any of Clauses 1 to 23, wherein the organosilane is glycidoxypropyltrimethoxy silane, the acid is acetic acid, and the metal alkoxide is zirconium propoxide.

Clause 25. A method for preparing a coated substrate, the method comprising:
applying a sol-gel coating to a metal substrate to form the sol-gel coating, the sol-gel coating comprising a corrosion inhibitor in an amount of about 3 wt % to about 15 wt %.

Clause 26. The method of Clause 25, further comprising:
applying a primer coating to the sol-gel coating to form the primer coating, the primer coating comprising a metal.

Clause 27. The method of Clauses 25 or 26, wherein applying the sol-gel coating comprises mixing the corrosion inhibitor with an organosilane and metal alkoxide, wherein a volume ratio of organosilane to metal alkoxide is about 5% to about 20%, wherein the metal alkoxide has been pretreated with an acid.

Clause 28. The method of any of Clauses 25 to 27, wherein the volume ratio of organosilane to metal alkoxide is about 9% to about 11%.

Clause 29. The method of any of Clauses 25 to 28, wherein the corrosion inhibitor upon the mixing has a D90 particle diameter of about 2 microns to about 5 microns.

Clause 30. The method of any of Clauses 25 to 29, further comprising pretreating the metal substrate before applying the sol-gel coating to the metal substrate.

Clause 31. The method of any of Clauses 25 to 30, wherein pretreating comprises immersing the metal substrate into a solution maintained between pH 3.7-3.95 using 1N H₂SO₄ or 1N NaOH.

Clause 32. The method of any of Clauses 25 to 31, wherein the solution comprises, per liter of the solution, about 3 grams to about 22 grams of a water-soluble trivalent chromium salt, about 1.5 grams to about 11.5 grams of an alkali metal hexafluorozirconate, about 0 grams to about 10 grams of a water-soluble thickener and about 0 grams to about 10 grams of a water-soluble surfactant selected from the group consisting of non-ionic surfactant, anionic surfactant, cationic surfactant, and combinations thereof.

Overall, the sol-gels of the present disclosure offer both standalone corrosion resistance and performance with non-chromate primers. The sol-gels of the present disclosure maintained suitable paint adhesion capabilities with the use of a corrosion inhibitor, and offered cathodic corrosion protection. The sol-gels of the present disclosure allow for an easily applied spray sol-gel having corrosion resistance properties that avoid the use of chromate primers, and do not contain heavy metals.

While we have described preferred aspects, those skilled in the art will readily recognize alternatives, variations, and modifications which might be made without departing from the inventive concept. Therefore, interpret the claims liberally with the support of the full range of equivalents known to those of ordinary skill based upon this description. The examples illustrate the present disclosure and are not intended to limit it. Accordingly, define the present disclosure with the claims and limit the claims only as necessary in view of the pertinent prior art.

We claim:

1. A coated substrate, comprising:
a metal substrate;
a sol-gel coating disposed on the metal substrate, the sol-gel coating comprising a sol-gel comprising:
a corrosion inhibitor,
a surfactant, and
a reaction product of an organosilane, a metal alkoxide, and an acid; and
an organic primer coating comprising an organic primer and disposed on the sol-gel coating, the organic primer coating having a plurality of metal particles.

2. The coated substrate of claim 1, wherein the corrosion inhibitor has two or more thiol moieties.

3. The coated substrate of claim 1, wherein the metal is selected from the group consisting of lithium, aluminum, magnesium, salts thereof, cations thereof, and combinations thereof.

4. The coated substrate of claim 3, wherein the metal is aluminum, a salt thereof, or a cation thereof.

5. The coated substrate of claim 3, wherein the organic primer is a polysiloxane or an epoxy.

6. The coated substrate of claim 5, wherein the epoxy is an amine-cured epoxy.

7. The coated substrate of claim 3, wherein the surfactant is an ethylene-oxide alcohol, a propylene-oxide alcohol, or an ethylene-oxide-propylene-oxide alcohol.

8. The coated substrate of claim 2, wherein the corrosion inhibitor is a mercaptothiadiazole.

9. The coated substrate of claim 8, wherein the dimercaptothiadiazole is 2,5-dimercapto-1,3,4-thiadiazole.

10. The coated substrate of claim 1, wherein the sol-gel coating has a concentration of the corrosion inhibitor of about 1 wt % to about 15 wt % by volume of the sol-gel coating.

11. The coated substrate of claim 1, wherein the organosilane is glycidoxypropyltrimethoxy silane, the acid is acetic acid, and the metal alkoxide is zirconium propoxide.

12. A method for preparing a coated substrate, the method comprising:
applying a sol-gel coating to a metal substrate to form the sol-gel coating, the sol-gel coating comprising a corrosion inhibitor; and
applying a primer coating to the sol-gel coating to form the primer coating, the primer coating comprising a metal.

13. The method of claim 12, wherein applying the sol-gel coating comprises mixing the corrosion inhibitor with an organosilane and metal alkoxide.

14. The method of claim 13, wherein a volume ratio of organosilane to metal alkoxide is about 5% to about 20%, wherein the metal alkoxide has been pretreated with an acid.

15. The method of claim 13, wherein the volume ratio of organosilane to metal alkoxide is about 9% to about 11%.

16. The method of claim 12, wherein the metal of the primer coating is a plurality of metal particles independently selected from the group consisting of aluminum, lithium, magnesium, salts thereof, cations thereof, and combinations thereof.

17. The method of claim 16, wherein the corrosion inhibitor upon the mixing has a D90 particle diameter of about 2 microns to about 5 microns.

18. The method of claim 12, further comprising pretreating the metal substrate before applying the sol-gel coating to the metal substrate.

19. The method of claim 18, wherein pretreating comprises immersing the metal substrate into a solution maintained between pH 3.7-3.95 using 1N H₂SO₄ or 1N NaOH.

20. The method of claim 19, wherein the solution comprises, per liter of the solution, about 3 grams to about 22 grams of a water-soluble trivalent chromium salt, about 1.5 grams to about 11.5 grams of an alkali metal hexafluorozirconate, about 0 grams to about 10 grams of a water-soluble thickener and about 0 grams to about 10 grams of a water-soluble surfactant selected from the group consisting of non-ionic surfactant, anionic surfactant, cationic surfactant, and combinations thereof.
